(19) United States
(12) Patent Application Publication
(10) Pub. No.: US 2014/0218347 A1
(43) Pub. Date: Aug. 7, 2014

(54) LIQUID CRYSTAL DISPLAY AND DRIVING METHOD THEREOF

(71) Applicant: SAMSUNG DISPLAY CO., LTD., Yongin-city (KR)

(72) Inventors: CHEOL-GON LEE, Seoul (KR); Chong Chul Chai, Seoul (KR); Joon-Chul Goh, Hwaseong-si (KR); Yeong-Keun Kwon, Yongin-si (KR); Jong Hee Kim, Hwaseong-si (KR)

(73) Assignee: SAMSUNG DISPLAY CO., LTD., Yongin-city (KR)

(21) Appl. No.: 14/167,868

(22) Filed: Jan. 29, 2014

(30) Foreign Application Priority Data
Feb. 1, 2013 (KR) 10-2013-0011723

(51) Int. Cl. G02F 1/1362; G09G 3/36

(52) U.S. Cl. CPC G02F 1/13624; G02F 1/136286; G09G 3/3688
USPC 345/211; 349/144; 349/42; 349/48

(57) ABSTRACT

In a liquid crystal display one pixel is divided into two subpixels, the two subpixels are connected to two subdata lines extending from one data line, and a desired data voltage is applied by using a data driving switching element connected to the subdata line, thereby reducing the number of data lines needed to reduce the cost of the driver and preventing a lack of space to mount the data driver while dividing one pixel into two subpixels and differently applying voltages of the two subpixels.

### CROSS-REFERENCE TO RELATED APPLICATION

This application claims priority to and the benefit of Korean Patent Application No. 10-2013-0011723 filed in the Korean Intellectual Property Office on Feb. 1, 2013, the entire contents of which are incorporated by reference herein.

### BACKGROUND

(a) Technical Field

The present disclosure relates to a liquid crystal display and a driving method of a liquid crystal display.

(b) Discussion of the Related Art

Liquid crystal displays (LCDs) are one of the most widely used flat panel displays. An LCD includes a pair of panels provided with field-generating electrodes, such as pixel electrodes and a common electrode, and a liquid crystal (LC) layer interposed between the two panels. The LCD displays images by applying voltages to the field-generating electrodes to generate an electric field in the LC layer that determines the orientations of LC molecules therein to adjust polarization of incident light.

The LCD also includes switching elements connected to the respective pixel electrodes, and a plurality of signal lines such as gate lines and data lines for controlling the switching elements and applying voltages to the pixel electrodes.

Among the LCDs, a vertical alignment (VA) mode LCD, which aligns LC molecules such that their long axes are perpendicular to the panels in the absence of an electric field, is desirable because of its high contrast ratio and wide reference viewing angle. Here, the reference viewing angle provides a viewing angle that is 1:10 in contrast ratio, or a critical angle of gray-to-gray luminance reversion.

To enable side visibility to be comparable to front visibility in the vertical alignment mode LCD, a method of causing a difference in transmittance by dividing one pixel into two subpixels and applying different voltages to the two subpixels has been suggested.

The liquid crystal display receives an input image signal from an external graphics controller, the input image signal containing luminance information of each pixel PX, the luminance having grays of a given value. Each pixel is supplied with a data voltage corresponding to the desired luminance information.

The driver of the liquid crystal display may be mounted on the display panel in a form of a plurality of IC chips, or may be installed on a flexible circuit film and attached to the display panel. However, the IC chip would result in a high manufacturing cost of the liquid crystal display, since the cost of the driver of the liquid crystal display would increase as the number of data lines applying the data voltage is increased. Also, as the resolution of the liquid crystal display is increased, the number of data lines is increased such that the space to mount the data driver becomes insufficient.

### SUMMARY

According to an exemplary embodiment of the liquid crystal display, and a driving method thereof, one pixel is divided into two subpixels to approximate lateral visibility to front visibility of a liquid crystal display. The number of data lines is reduced to reduce cost of a driver of the liquid crystal display while applying voltages to the two subpixels differently, thereby preventing a lack of space to mount a data driver of a high resolution liquid crystal display.

A liquid crystal display according to an exemplary embodiment of the present invention includes: a plurality of pixels disposed in a pixel row direction and a pixel column direction and including a first subpixel electrode and a second subpixel electrode; and a plurality of gate lines and a plurality of data lines connected to the plurality of pixels. The plurality of data lines respectively include a first subdata line and a second subdata line. The first subpixel electrode and the second subpixel electrode of a plurality of pixels are positioned at the same pixel row among the plurality of pixels are connected to the same gate line. The first subpixel electrode of a plurality of pixels is positioned at the same pixel column among the plurality of pixels is connected to one of the first subdata line and the second subdata line, while the second subpixel electrode is connected to the other of the first subdata line and the second subdata line.

Absolute values of a first data voltage applied to the first subpixel electrode and a second data voltage applied to the second subpixel electrode may be different from each other.

A first driving gate line extending in the same direction as the gate line, and a first driving transistor connected to the first driving gate line, the data line, and the first subdata line, may be further included. A second driving gate line extending in the same direction as the gate line, and a second driving transistor connected to the second driving gate line, the data line, and the second subdata line, may be further included.

The plurality of gate lines may include a first gate line connected to the first pixel row among the plurality of pixels and a second gate line connected to the second pixel row adjacent to the first pixel row among the plurality of pixels and positioned close to the first gate line. The plurality of data lines may include a first data line and a second data line positioned close to the first data line, and a first subdata line of the first data line may be connected to a first subpixel electrode of a pixel positioned at a first pixel row and a first pixel column among the plurality of pixels. A second subdata line of the first data line may be connected to a second subpixel electrode of a pixel positioned at the first pixel row and a second pixel column. A first subdata line of the second data line may be connected to the first subpixel electrode of the pixel positioned at the first pixel row and the second pixel column. The second subdata line of the second data line may be connected to the second subpixel electrode of the pixel positioned at the first pixel row and the first pixel column.

The first subdata line of the first data line may be connected to a second subpixel electrode of a pixel positioned at a second pixel row and the first pixel column among the plurality of pixels. The second subdata line of the first data line may be connected to a first subpixel electrode of a pixel positioned at a second pixel row and the second pixel column. The first subdata line of the second data line may be connected to a second subpixel electrode of the pixel positioned at the second pixel row and the second pixel column of the pixel. A second subdata line of the second data line may be connected to the first subpixel electrode of the pixel positioned at the second pixel row and the first pixel column of the pixel.

A first driving gate line extending in the same direction as the gate line, and a first driving transistor connected to the first driving gate line, the data line, and the first subdata line, may be further included.

A second driving gate line extending in the same direction as the gate line, and a second driving transistor connected to the second driving gate line, the data line, and the second subdata line, may be further included.

The plurality of data lines may include the first subdata line of the first data line, the second subdata line of the second data line, the first subdata line of the second data line, and the second subdata line of the first data line, sequentially positioned.

The plurality of data lines may include the first subdata line of the first data line, the second subdata line of the second data line, the second subdata line of the first data line, and the first subdata line of the second data line, sequentially positioned.

The plurality of pixels may include a first pixel column and a fourth pixel column displaying a first color, a second pixel column and a fifth pixel column displaying a second color, and a third pixel column and a sixth pixel column displaying a third color. The plurality of data lines may include a first data line and a fourth data line connected to the first pixel column and the fourth pixel column, a second data line and a fifth data line connected to the second pixel column and the fifth pixel column, and a third data line and a sixth data line connected to the third pixel column and the sixth pixel column. A first subdata line of the first data line may be connected to the first subpixel electrode of a pixel positioned at the first pixel column. A second subdata line of the first data line may be connected to the second subpixel electrode of a pixel positioned at the fourth pixel column. A first subdata line of the fourth data line may be connected to the first subpixel electrode of a pixel positioned at the fourth pixel column. A second subdata line of the fourth data line may be connected to a second subpixel electrode of the first pixel column.

A first subdata line of the second data line may be connected to a first subpixel electrode of a pixel positioned at the second pixel column. A second subdata line of the second data line may be connected to the second subpixel electrode of a pixel positioned at a fifth pixel column. A first subdata line of the fifth data line may be connected to a first subpixel electrode of a pixel positioned at the fifth pixel column. A second subdata line of the fifth data line may be connected to a second subpixel electrode of the second pixel column.

A first subdata line of the third data line may be connected to a first subpixel electrode of the pixel positioned at the third pixel column. A second subdata line of the third data line may be connected to a second subpixel electrode of the pixel positioned at the sixth pixel column. A first subdata line of the sixth data line may be connected to a first subpixel electrode of a pixel positioned at the sixth pixel column. A second subdata line of the sixth data line may be connected to a second subpixel electrode of the third pixel column.

A driving method according to an exemplary embodiment of the present invention for driving a liquid crystal display including a plurality of pixels disposed in a pixel row direction and a pixel column direction and including a first subpixel electrode, a second subpixel electrode, a plurality of gate lines and a plurality of data lines connected to a plurality of pixels, and wherein the plurality of data lines respectively include a first subdata line and a second subdata line. The method includes: applying a gate-on signal to the plurality of gate lines; applying a first data signal to the first subdata line during a first time among application of the gate-on signal to apply the first data signal to the first subpixel electrode; and applying a second data signal to the second subdata line during a second time among the application of the gate-on signal to apply the second data signal to the second subpixel electrode.

Absolute values of a first data voltage applied to the first subpixel electrode and a second data voltage applied to the second subpixel electrode may be different from each other.

The application of the first data signal to the first subdata line may further include turning on a first driving transistor connected to a first driving gate line extending in the same direction as a gate line, a data line, and the first subdata line.

The application of the second data signal to the second subdata line may include turning on a second driving transistor connected to a second driving gate line extending in the same direction as the gate line, the data line, and the second subdata line.

The first time and the second time may be about half of a maintaining time of the application step of the gate-on signal.

At least a portion of the first time and the second time may overlap each other.

The method may further include applying the first data signal to the second subdata line during the first time.

The method may further include applying a second data signal to the first subdata line during the second time.

The first data signal applied to the first subdata line and the second data signal applied to the second subdata line may be driven through column inversion.

The first data signal applied to the first subdata line and the second data signal applied to the second subdata line may be driven through dot inversion.

One pixel is divided into two subpixels, the two subpixels are connected to two subdata lines extending from one data line, and a desired data voltage is applied by using a data driving switching element connected to the subdata line, thereby reducing the number of data lines to reduce the cost of the driver and preventing a lack of space to mount the data driver while dividing one pixel into two subpixels and differently applying the voltages of the two subpixels.

According to an exemplary embodiment of the present invention, an electrode apparatus for a liquid crystal display is provided. A first pixel electrode and a second pixel electrode are connected to a respective first switching element and a second switching element, the first switching element and the second switching element having a respective control electrode of a first gate electrode and a second gate electrode, a respective input electrode of a first source electrode and a second source electrode, and a respective output electrode of a first drain electrode and a second drain electrode, a channel region of the first switching element and the second switching element being formed in a first semiconductor and a second semiconductor.

The first gate electrode and the second gate electrode are each connected to a gate line. The first source electrode is connected to a first subdata line of a data line. The second source electrode is connected to a second subdata line of the data line. The first drain electrode and the second drain electrode are respectively connected to the first pixel electrode and the second pixel electrode. The first pixel electrode and the second pixel electrode are formed with the same layer and are disposed adjacent each other in a column direction with respect to the gate line.

An overall shape of the first pixel electrode and the second pixel electrode may be a quadrangle and may include a cross-shaped stem and a plurality of minute branches extending from the stem.

Each pixel electrode may have four sub-regions defined by the cross-shaped stem in which a plurality of minute branches extend in different directions.

The plurality of minute branches may form an angle of about 45 degrees or 135 degrees with respect to the gate line, and a plurality of minute branches of two neighboring sub-regions may extend perpendicular to each other.

### BRIEF DESCRIPTION OF THE DRAWINGS

FIG. 1 is a layout view of an arrangement of a signal line and a pixel of a liquid crystal display according to an exemplary embodiment of the present invention.

FIG. 2 is a waveform diagram of a signal applied to the signal line of the liquid crystal display of FIG. 1.

FIG. 3 is a layout view to explain a polarity of a signal applied to a liquid crystal display according to the exemplary embodiment of FIG. 1 and FIG. 2.

FIG. 4 is a layout view of a pixel of a liquid crystal display according to an exemplary embodiment of the present invention.

FIG. 5 is a layout view of an arrangement of a signal line and a pixel of a liquid crystal display according to another exemplary embodiment of the present invention.

FIG. 6 is a waveform diagram of a signal applied to the signal line of the liquid crystal display of FIG. 5.

FIG. 7 is a layout view of an arrangement of a signal line and a pixel of a liquid crystal display according to another exemplary embodiment of the present invention.

FIG. 8 is a waveform diagram of a signal applied to the signal line of the liquid crystal display of FIG. 7.

FIG. 9 to FIG. 11 are waveform diagrams of a signal applied to the signal line of a liquid crystal display according to exemplary embodiments of the present invention.

FIG. 12 is a layout view of an arrangement of a signal line and a pixel of a liquid crystal display according to another exemplary embodiment of the present invention.

FIG. 13 is a waveform diagram of a signal applied to the signal line of the liquid crystal display of FIG. 12.

FIG. 14 is a layout view of an arrangement of a signal line and a pixel of a liquid crystal display according to another exemplary embodiment of the present invention.

FIG. 15 is a waveform diagram of a signal applied to the signal line of the liquid crystal display of FIG. 14.

FIG. 16 is a layout view of an arrangement of a signal line and a pixel of a liquid crystal display according to another exemplary embodiment of the present invention.

FIG. 17 is a waveform diagram of a signal applied to the signal line of the liquid crystal display of FIG. 16.

FIG. 18 is a layout view of an arrangement of a signal line and a pixel of a liquid crystal display according to another exemplary embodiment of the present invention.

FIG. 19 is a waveform diagram of a signal applied to the signal line of the liquid crystal display of FIG. 18.

FIG. 20 is a layout view of an arrangement of a signal line and a pixel of a liquid crystal display according to another exemplary embodiment of the present invention.

### DETAILED DESCRIPTION OF THE EMBODIMENTS

Exemplary embodiments of the present invention will be described more fully hereinafter with reference to the accompanying drawings. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

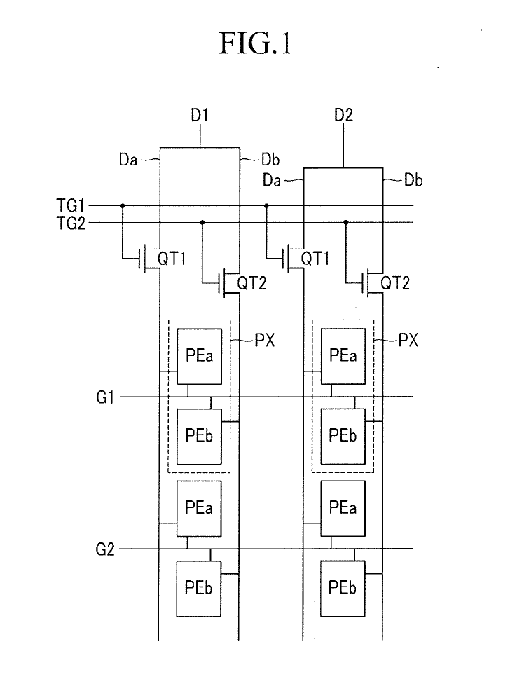

A liquid crystal display according to an exemplary embodiment of the present invention will now be described with reference to FIG. 1.

As seen in FIG. 1, a liquid crystal display according to an exemplary embodiment of the present invention includes a plurality of gate lines G1, G2 extending in a first direction, a plurality of data lines D1, D2 extending in a second direction, and a plurality of pixels PX connected to the gate lines and the data lines and arranged in a matrix shape.

The first gate line G1 of the plurality of gate lines G1, G2 is connected to a plurality of pixels PX positioned in a first pixel row among the plurality of pixels, and the second gate line G2 is connected to a plurality of pixels PX positioned in a second pixel row adjacent to the first pixel row among the plurality of pixels PX.

The plurality of data lines D1, D2 respectively include a first subdata line Da and a second subdata line Db. The first data line D1 among the plurality of data lines D1, D2 is connected to a plurality of pixels PX positioned at a first pixel column among the plurality of pixels PX, and the second data line D2 is connected to a plurality of pixels PX positioned at a second pixel column adjacent to the first pixel column among the plurality of pixels PX.

The plurality of pixels PX respectively include a first subpixel electrode PEa and a second subpixel electrode PEb.

The first subdata line Da of the first data line D1 is connected to the first subpixel electrodes PEa of the plurality of pixels PX positioned at the first pixel column, and the second subdata line Db of the first data line D1 is connected to the second subpixel electrodes PEb of the plurality of pixels PX positioned at the first pixel column. Similarly, the first subdata line Da of the second data line D2 is connected to the first subpixel electrodes PEa of the plurality of pixels PX positioned at the second pixel column, and the second subdata line Db of the second data line D2 is connected to the second subpixel electrodes PEb of the plurality of pixels PX positioned at the second pixel column.

The liquid crystal display according to the present exemplary embodiment further includes a first driving gate line TG1 and a second driving gate line TG2. Also, the liquid crystal display according to the present exemplary embodiment further includes a first driving transistor QT1 connected to the first driving gate line TG1, the data lines D1, D2, and the first subdata line Da of each data line D1, D2. A second driving transistor QT2 is connected to the second driving gate line TG2, the data lines D1, D2, and the second subdata line Db of each data line D1, D2.

Although not shown, the first subpixel electrode PEa of each pixel PX is connected to the gate lines G1, G2 and the first subdata line Da of the data lines D1, D2 through a switching element such as a thin film transistor, and the second subpixel electrode PEb of each pixel PX is connected to the gate lines G1, G2 and the second subdata line Db of the data lines D1, D2 through the switching element such as the thin film transistor.

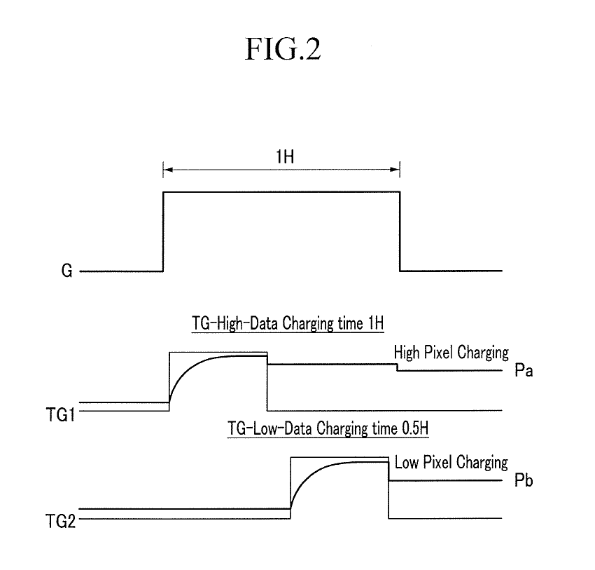

Next, a driving method of a liquid crystal display according to the exemplary embodiment shown in FIG. 1 will be described with reference to FIG. 2. FIG. 2 is a waveform diagram of signals applied to signal lines of the liquid crystal display of FIG. 1. In FIG. 2, a gate signal applied to the plurality of gate lines G1, G2 is indicated by G. Gate signals applied to the first driving gate line TG1 and the second driving gate line TG2 are indicated by TG1 and TG2. A data voltage applied to the first subpixel electrodes PEa of the plurality of pixels PX is indicated by Pa. A data voltage applied to the second subpixel electrodes PEb of the plurality of pixels PX is indicated by Pb.

Referring to FIG. 1 and FIG. 2, if a gate-on voltage is applied to the first gate line G1 of the plurality of gate lines G1, G2, the switching element connected to the first subpixel electrode PEa and the second subpixel electrodes PEb of the plurality of pixels PX positioned at the first pixel row connected to the first gate line G1 is turned on.

As the gate-on voltage is applied to the first gate line G1 and simultaneously the gate-on voltage is also applied to the first driving gate line TG1 such that the first driving transistor QT1 is turned on, the first data signal Pa applied to the data lines D1, D2 is applied to the first subpixel electrodes PEa of the pixels PX of the first pixel row, the first pixel column, and the second pixel column through the first subdata line Da. Next, the signal applied to the first driving gate line TG1 is changed into a gate-off voltage, and the gate-on voltage is applied to the second driving gate line TG2. Accordingly, the driving transistor QT1 is turned off and the second driving transistor QT2 is turned on such that the second data signal Pb applied to the data lines D1, D2 is applied to the second subpixel electrodes PEb of the pixels PX of the first pixel row, the first pixel column, and the second pixel column through the second subdata line Db.

Next, if the gate signal G applied to the first gate line G1 is changed from the gate-on signal to the gate-off signal and simultaneously the second gate line G2 is supplied with the gate-on signal, the switching element connected to the first subpixel electrode PEa and the second subpixel electrodes PEb of the plurality of pixels PX positioned at the second pixel row connected to the first gate line G1 is turned on.

As the second gate line G2 is supplied with the gate-on voltage and simultaneously the first driving gate line TG1 is supplied with the gate-on voltage such that the first driving transistor QT1 is turned on, the first data signal Pa applied to the data lines D1, D2 is applied to the first subpixel electrodes PEa of the pixels PX of the second pixel row, the first pixel column, and the second pixel column through the first subdata line Da. Next, the signal applied to the first driving gate line TG1 is changed into the gate-off voltage and the gate-on voltage is applied to the second driving gate line TG2. Accordingly, the driving transistor QT1 is turned off and the second driving transistor QT2 is turned on such that the second data signal Pb applied to the data lines D1, D2 is applied to the second subpixel electrodes PEb of the pixels PX of the second pixel row, the first pixel column, and the second pixel column through the second subdata line Db.

This step is sequentially repeated such that the different voltages Pa, Pb are applied to the first subpixel electrode PEa and the second subpixel electrode PEb for each pixel PX of the liquid crystal display. The value of the first data voltage Pa applied to the first subpixel electrode PEa (absent polarity) is larger than the value of the second data voltage Pb applied to the second subpixel electrode PEb (absent polarity).

Referring to FIG. 2, a period in which the first driving gate line TG1 is supplied with the gate-on voltage is an initial half of a period 1 H in which the gate lines G1, G2 are supplied with the gate-on signal, and a period in which the second driving gate line TG2 is supplied with the gate-on voltage is a latter about half of the period 1 H in which the gate lines G1, G2 are supplied with the gate-on signal. That is, the gate-on voltage is applied to the first driving gate line TG1 during the initial about half period of the period 1 H in which the gate-on signal is applied to the gate lines G1, G2, and the gate-on voltage is applied to the second driving gate line TG2 during the latter about half period among the period 1 H in which the gate-on signal is applied to the gate lines G1, G2.

Therefore, the first data voltage Pa is applied to the first subpixel electrode PEa of each pixel PX during the initial about half a period in which the gate-on signal is applied among the period 1 H, and is charged to the first subpixel electrode PEa during a period that the gate-on voltage applied to the gate lines G1, G2 is maintained. On the other hand, the second data voltage Pb is applied to the second subpixel electrode PEb of each pixel PX during the latter about half a period among the period 1 H in which the gate-on signal is applied and is charged to the second subpixel electrode PEb during about half of the period that the gate-on voltage applied to the gate lines G1, G2 is maintained. As described above, since the value of the first data voltage Pa applied to the first subpixel electrode PEa is larger than the value of the second data voltage Pb applied to the second subpixel electrode PEb, the charging time of the first data voltage Pa having the large value is long and the charging time of the second data voltage Pb having the smaller value is short. As such, deterioration of the data voltage charged to the second subpixel electrode PEb may be decreased.

According to the exemplary embodiment of the present invention, each pixel PX is divided into the two subpixel electrodes PEa, PEb, the two subpixel electrodes PEa, PEb being connected to the two subdata lines Da and Db extended from the data lines D1, D2, and the desired data voltage being applied by using the data driving switching elements QT1 and QT2 connected to the two subdata lines Da and Db. Thereby, the data voltages of the different magnitudes may be applied to the two subpixel electrodes PEa, PEb while reducing the number of the data lines by half. Accordingly, while improving the lateral visibility of the liquid crystal display, the cost of the driver can be reduced and a lack of space to mount the data driver can be prevented.

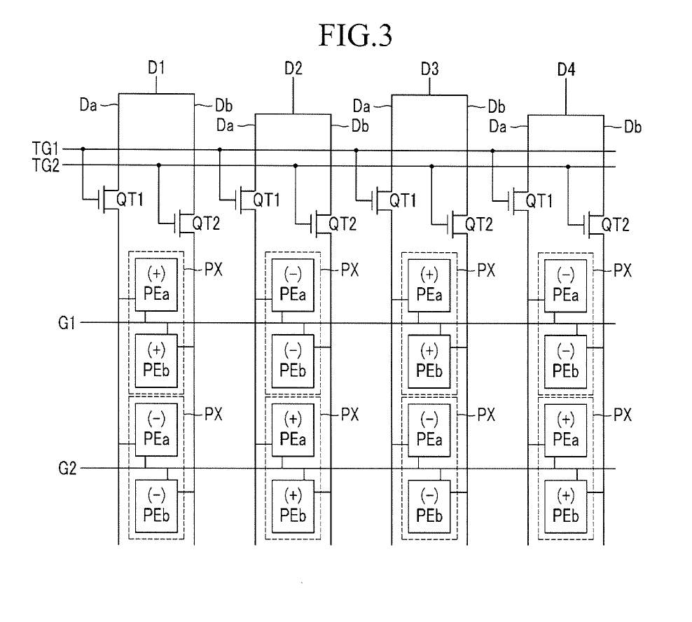

The polarity of the first data voltage Pa and the second data voltage Pb applied to the first subpixel electrode PEa and the second subpixel electrode PEb in each pixel PX of the liquid crystal display according to the exemplary embodiment shown in FIG. 1 and FIG. 2 will be described with reference to FIG. 3.

For the polarity of the first data voltage Pa and the second data voltage Pb applied to the first subpixel electrodes PEa and the second subpixel electrodes PEb of the plurality of pixels PX positioned at the first pixel column through the first data line D1 connected to the first pixel column, a positive polarity (+) and a negative polarity (−) are sequentially repeated for each pixel PX. For the polarity of the first data voltage Pa and the second data voltage Pb applied to the first subpixel electrodes PEa and the second subpixel electrodes PEb of the plurality of pixels PX positioned at the second pixel column through the second data line D2, the negative polarity (−) and the positive polarity (+) are sequentially repeated for each pixel PX. Similarly, for the polarity of the first data voltage Pa and the second data voltage Pb applied to the first subpixel electrodes PEa and the second subpixel electrodes PEb of a plurality of pixels PX positioned at the third pixel column adjacent to the second pixel column through a third data line D3 adjacent to the second data line D2, the positive polarity (+) and the negative polarity (−) are sequentially repeated for each pixel PX. For the polarity of the first data voltage Pa and the second data voltage Pb applied to the first subpixel electrodes PEa and the second subpixel electrodes PEb of a plurality of pixels PX positioned at the fourth pixel column adjacent to the third pixel column through a fourth data line D4 adjacent to the third data line D3, the negative polarity (−) and the positive polarity (+) are sequentially repeated for each pixel PX. That is, the polarity of the data voltage applied to the data lines D1, D2, D3, D4 is determined through dot inversion, and apparent inversion of the pixel PX is also dot inversion.

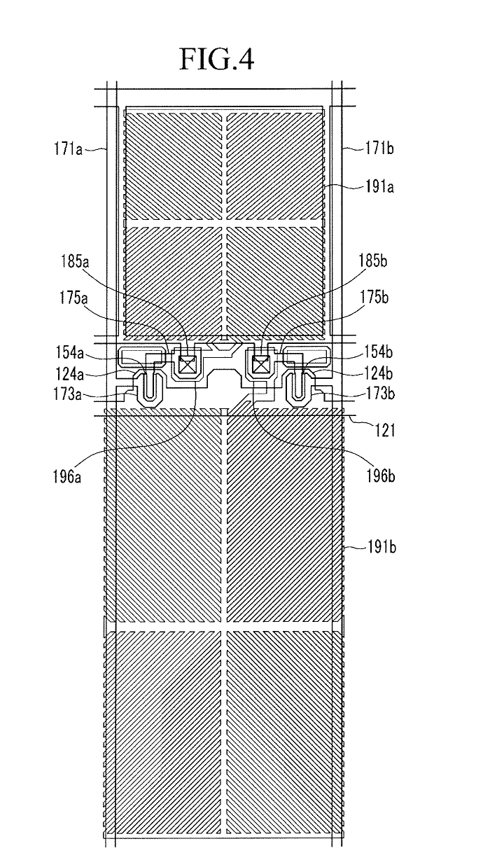

Next, an example of a pixel structure of a liquid crystal display according to an exemplary embodiment of the present invention will be described with reference to FIG. 4, which is a layout view of one pixel of the liquid crystal display.

Referring to FIG. 4, the liquid crystal display according to the present exemplary embodiment includes a first pixel electrode 191a and a second pixel electrode 191b connected to a first switching element and a second switching element. The first switching element and the second switching element are three terminal elements, such as a thin film transistor, have a control electrode of a first gate electrode 124a and a second gate electrode 124b, an input electrode of a first source electrode 173a and a second source electrode 173b, and an output electrode of a first drain electrode 175a and a second drain electrode 175b. A channel region of the first switch element and the second switching element is formed in a first semiconductor 154a and a second semiconductor 154b positioned between the first source electrode 173a and second source electrode 173b and the first drain electrode 175a and second drain electrode 175b.

The first gate electrode 124a and the second gate electrode 124b are connected to a gate line 121, the first source electrode 173a is connected to a first subdata line 171a of the data line, and the second source electrode 173b is connected to a second subdata line 171b of the data line. The first drain electrode 175a and the second drain electrode 175b are connected to the first pixel electrode 191a and the second pixel electrode 191b through a first contact hole 185a and a second contact hole 185b.

The first pixel electrode 191a and the second pixel electrode 191b are formed with the same layer and are disposed to be close to each other in the column direction with respect to the gate line 121.

An overall shape of the first pixel electrode 191a and the second pixel electrode 191b is a quadrangle, and includes a cross-shaped stem and a plurality of minute branches extending from the stem. Each pixel has four subregions defined by the cross-shaped stem in which a plurality of minute branches extend in different directions.

The plurality of minute branches form an angle of about 45 degrees or 135 degrees with respect to the gate line 121, and a plurality of minute branches of two neighboring sub-regions may extend perpendicular to each other.

However, the pixel structure according to the exemplary embodiment shown in FIG. 4 is only one example, and an exemplary embodiment of the present invention may be applied to all pixel structures in which one pixel is divided into two subpixel electrodes connected to the same gate line and different subdata lines.

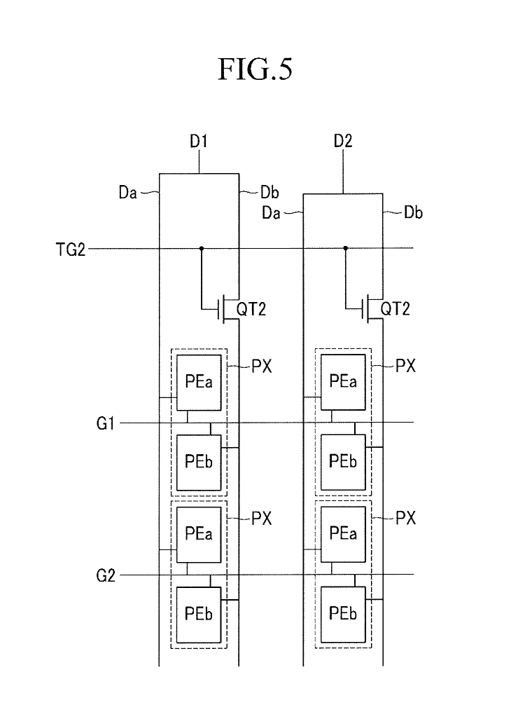

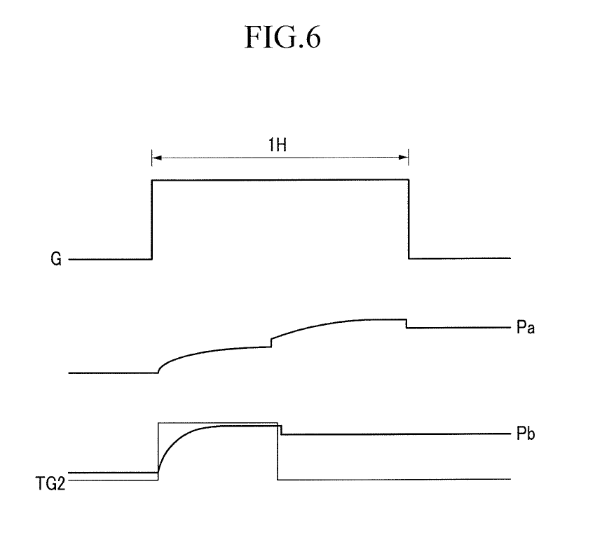

Next, a liquid crystal display and a driving method thereof according to another exemplary embodiment of the present invention will be described with reference to FIG. 5 and FIG. 6, FIG. 5 being a layout view of an arrangement of a signal lines and pixels of a liquid crystal display, and FIG. 6 being a waveform diagram of a signal applied to the signal lines of the liquid crystal display of FIG. 5.

Firstly, referring to FIG. 5, the liquid crystal display according to the present exemplary embodiment is similar to the liquid crystal display according to the exemplary embodiment shown in FIG. 1.

However, the liquid crystal display according to the present exemplary embodiment, is different from the liquid crystal display according to the exemplary embodiment shown in FIG. 1, in that it does not include the first driving gate line TG1 and the first driving transistor QT1 connected to the first subdata line Da of the data lines D1, D2.

In more detail, a liquid crystal display according to the present exemplary embodiment includes a plurality of gate lines G1, G2 extending in a first direction, a plurality of data lines D1, D2 extending in a second direction, and a plurality of pixels PX connected to the gate lines and the data lines and arranged in a matrix shape.

The first gate line G1 of the plurality of gate lines G1, G2 is connected to a plurality of pixels PX positioned at the first pixel row among the plurality of pixels PX, and the second gate line G2 is connected to a plurality of pixels PX positioned at the second pixel row adjacent to the first pixel row among the plurality of pixels PX.

The plurality of data lines D1, D2 respectively include a first subdata line Da and a second subdata line Db. The first data line D1 among the plurality of data lines D1, D2 is connected to the plurality of pixels PX positioned at the first pixel column among the plurality of pixels PX. The second data line D2 is connected to the plurality of pixels PX positioned at the second pixel column adjacent to the first pixel column among the plurality of pixels PX.

The plurality of pixels PX respectively include a first subpixel electrode PEa and a second subpixel electrode PEb.

The first subdata line Da of the first data line D1 is connected to the first subpixel electrodes PEa of the plurality of pixels PX positioned at the first pixel column, and the second subdata line Db of the first data line D1 is connected to the second subpixel electrodes PEb of the plurality of pixels PX positioned at the first pixel column. Similarly, the first subdata line Da of the second data line D2 is connected to the first subpixel electrodes PEa of the plurality of pixels PX positioned at the second pixel column, and the second subdata line Db of the second data line D2 is connected to the second subpixel electrodes PEb of the plurality of pixels PX positioned at the second pixel column.

The liquid crystal display according to the present exemplary embodiment further includes a second driving gate line TG2, the data lines D1, D2, and a second driving transistor QT2 connected to the second subdata line Db of the data lines D1, D2.

Although not shown, the first subpixel electrode PEa of each pixel PX is connected to the gate lines G1, G2 and the first subdata line Da of the data lines D1, D2 through a switching element such as a thin film transistor, and the second subpixel electrode PEb of each pixel PX is connected to the gate lines G1, G2 and the second subdata line Db of the data lines D1, D2 through the switching element such as the thin film transistor.

Next, a driving method of a liquid crystal display according to the exemplary embodiment shown in FIG. 5 will be described with reference to FIG. 6. In FIG. 6, a gate signal applied to the plurality of gate lines G1, G2 is indicated by G, a gate signal applied to the second driving gate line TG2 is indicated by TG2, a data voltage applied to the first subpixel electrodes PEa of the plurality of pixels PX is indicated by Pa, and a data voltage applied to the second subpixel electrodes PEb of the plurality of pixels PX is indicated by Pb.

Referring to both FIG. 6 and FIG. 5, if a gate-on voltage is applied to the first gate line G1 of the plurality of gate lines G1, G2, the switching element connected to the first subpixel electrodes PEa and the second subpixel electrodes PEb of the plurality of pixels PX positioned at the first pixel row connected to the first gate line G1 is turned on.

As the gate-on voltage is applied to the first gate line G1 and simultaneously the gate-on voltage is also applied to the second driving gate line TG2 such that the second driving transistor QT2 is turned on, the second data signal Pb applied to the data lines D1, D2 is applied to the second subpixel electrodes PEb of the pixels PX of the first pixel row, the first pixel column, and the second pixel column through the second subdata line Db. Simultaneously, the second data signal Pb applied to the data lines D1, D2 is applied to the first subpixel electrodes PEa of the pixels PX of the first pixel row, the first pixel column, and the second pixel column through the first subdata line Da.

Next, if the signal applied to the second driving gate line TG2 is changed into the gate-off voltage, the signal is not applied to the second subdata line Db connected to the second subpixel electrode PEb, and the first data signal Pa of the data lines D1, D2 is applied to the first subpixel electrodes PEa of the pixels PX of the first pixel row, the first pixel column, and the second pixel column through the first subdata line Da.

That is, after the first subpixel electrode PEa is pre-charged by the second data signal Pb applied to the second subpixel electrode PEb, the first data signal Pa is changed. Also, in the case of the second subpixel electrode PEb, the first gate line G1 is supplied with the gate-on voltage and simultaneously the second data signal Pb is applied such that the charging time of the second data signal Pb is long.

Next, if the gate signal G applied to the first gate line G1 is changed from the gate-on signal to the gate-off signal and simultaneously the second gate line G2 is supplied with the gate-on signal, the switching element connected to the first subpixel electrodes PEa and the second subpixel electrodes PEb of the plurality of pixels PX positioned at the second pixel row connected to the first gate line G1 is turned on.

As the second gate line G2 is supplied with the gate-on voltage and simultaneously the second driving gate line TG2 is supplied with the gate-on voltage such that the second driving transistor QT2 is turned on, the second data signal Pb applied to the data lines D1, D2 is applied to the second subpixel electrodes PEb of the pixels PX of the second pixel row, the first pixel column, and the second pixel column through the second subdata line Db. Simultaneously, the second data signal Pb applied to the data lines D1, D2 is applied to the first subpixel electrodes PEa of the pixels PX of the second pixel row, the first pixel column, and the second pixel column through the first subdata line Da.

Next, if the signal applied to the second driving gate line TG2 is changed into the gate-off voltage, the signal is not applied to the second subdata line Db connected to the second subpixel electrode PEb, and the first data signal Pa applied to the data lines D1, D2 is applied to the first subpixel electrodes PEa of the pixels PX of the second pixel row, the first pixel column, and the second pixel column through the first subdata line Da.

This step is sequentially repeated such that the different voltages Pa, Pb are applied to the first subpixel electrode PEa and the second subpixel electrode PEb for each pixel PX of the liquid crystal display. The absolute value of the first data voltage Pa applied to the first subpixel electrode PEa is larger than the absolute value of the second data voltage Pb applied to the second subpixel electrode PEb.

Referring to FIG. 6, the period in which the second driving gate line TG2 is supplied with the gate-on voltage is the initial about half a period of the period 1 H in which the gate lines G1, G2 are supplied with the gate-on signal. Also, the first subpixel electrode PEa is directly connected to the first subdata line Da of the data lines D1, D2 without the first driving transistor QT1. Accordingly, after the first subpixel electrode PEa is pre-charged by the second data signal Pb applied to the second subpixel electrode PEb, the first data signal Pa is charged. Also, in the case of the second subpixel electrode PEb, the first gate line G1 is supplied with the gate-on voltage and simultaneously the second data signal Pb is applied such that the charging time of the second data signal Pb is long.

Therefore, the charging time deterioration of the data voltage charged to the first subpixel electrode PEa and the second subpixel electrode PEb can be prevented.

According to an exemplary embodiment of the present invention, each pixel PX is divided into two subpixel electrodes PEa, PEb. The two subpixel electrodes PEa, PEb are connected to the two subdata lines Da, Db extended from the data lines D1, D2. The desired data voltage is applied by using the data driving switching element QT2 connected to the second subdata line Db among the two subdata lines Da, Db. Thereby the data voltages of the different magnitudes can be applied to the two subpixel electrodes PEa, PEb while reducing the number of the data lines by half. Accordingly, while improving the lateral visibility of the liquid crystal display, a cost of the driver can be reduced and a lack of space to mount the data driver can be prevented.

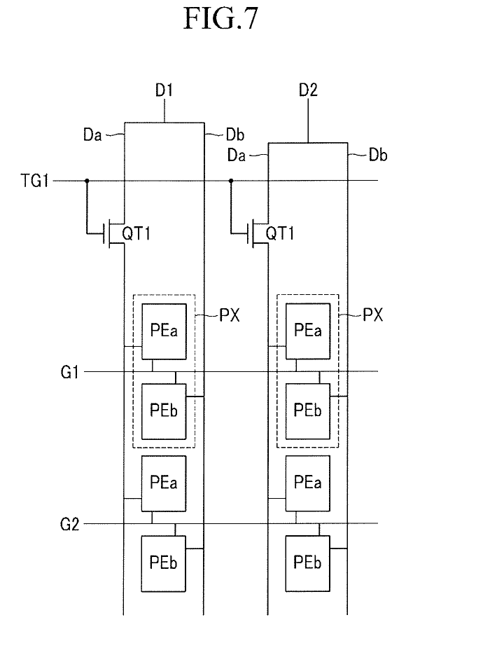

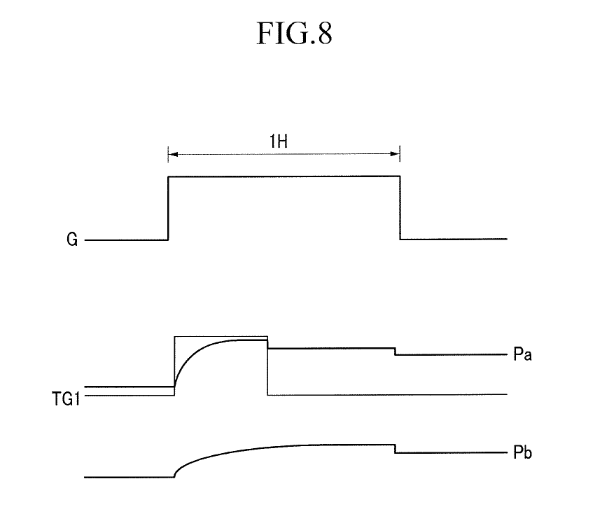

Next, a liquid crystal display and a driving method thereof according to another exemplary embodiment of the present invention will be described with reference to FIG. 7 and FIG. 8, FIG. 7 being a layout view of an arrangement of a signal line and a pixel of a liquid crystal display according to another exemplary embodiment of the present invention, and FIG. 8 being a waveform diagram of a signal applied to the signal line of the liquid crystal display of FIG. 7.

Firstly, referring to FIG. 7, the liquid crystal display according to the present exemplary embodiment is similar to the liquid crystal display according to the exemplary embodiment shown in FIG. 1.

However, the liquid crystal display according to the present exemplary embodiment, is different from the liquid crystal display according to the exemplary embodiment shown in FIG. 1, in that it does not include the second driving gate line TG2 and the second driving transistor QT2 connected to the second subdata line Db of the data lines D1, D2.

In more detail, a liquid crystal display according to the present exemplary embodiment includes a plurality of gate lines G1, G2 extending in a first direction, a plurality of data lines D1, D2 extending in a second direction, and a plurality of pixels PX is connected to the gate lines and the data lines and arranged in a matrix shape.

The first gate line G1 of the plurality of gate lines G1, G2 is connected to the plurality of pixels PX positioned at the first pixel row among the plurality of pixels PX, and the second gate line G2 is connected to the plurality of pixels PX positioned at the second pixel row adjacent to the first pixel row among the plurality of pixels PX.

The plurality of data lines D1, D2 respectively include a first subdata line Da and a second subdata line Db. The first data line D1 among the plurality of data lines D1, D2 is connected to the plurality of pixels PX positioned at the first pixel column among the plurality of pixels PX. The second data line D2 is connected to the plurality of pixels PX positioned at the second pixel column adjacent to the first pixel column among the plurality of pixels PX.

The plurality of pixels PX respectively include a first subpixel electrode PEa and a second subpixel electrode PEb.

The first subdata line Da of the first data line D1 is connected to the first subpixel electrodes PEa of the plurality of pixels PX positioned at the first pixel column. The second subdata line Db of the first data line D1 is connected to the second subpixel electrodes PEb of the plurality of pixels PX positioned at the first pixel column. Similarly, the first subdata line Da of the second data line D2 is connected to the first subpixel electrodes PEa of the plurality of pixels PX positioned at the second pixel column. The second subdata line Db of the second data line D2 is connected to the second subpixel electrodes PEb of the plurality of pixels PX positioned at the second pixel column.

The liquid crystal display according to the present exemplary embodiment further includes a second driving gate line TG2, the data lines D1, D2, and a first driving transistor QT1 connected to the first subdata line Da of the data lines D1, D2.

Although not shown, the first subpixel electrode PEa of each pixel PX is connected to the gate lines G1, G2 and the first subdata line Da of the data lines D1, D2 through a switching element such as a thin film transistor, and the second subpixel electrode PEb of each pixel PX is connected to the gate lines G1, G2 and the second subdata line Db of the data lines D1, D2 through the switching element such as the thin film transistor.

Next, a driving method of a liquid crystal display according to the exemplary embodiment shown in FIG. 7 will be described with reference to FIG. 8. In FIG. 8, a gate signal applied to a plurality of gate lines G1, G2 is indicated by G, a gate signal applied to the first driving gate line TG1 is indicated by TG1, a data voltage applied to the first subpixel electrodes PEa of the plurality of pixels PX is indicated by Pa, and a data voltage applied to the second subpixel electrodes PEb of the plurality of pixels PX is indicated by Pb.

Referring to FIG. 8 along with FIG. 7, if a gate-on voltage is applied to the first gate line G1 of the plurality of gate lines G1, G2, the switching element connected to the first subpixel electrode PEa and the second subpixel electrodes PEb of the plurality of pixels PX positioned at the first pixel row connected to the first gate line G1 is turned on.

As the gate-on voltage is applied to the first gate line G1 and simultaneously the gate-on voltage is also applied to the first driving gate line TG1 such that the first driving transistor QT1 is turned on, the first data signal Pa applied to the data lines D1, D2 is applied to the first subpixel electrodes PEa of the pixels PX of the first pixel row, the first pixel column, and the second pixel column through the first subdata line Da. Simultaneously, the first data signal Pa applied to the data lines D1, D2 is applied to the second subpixel electrodes PEb of the pixels PX of the first pixel row, the first pixel column, and the second pixel column through the second subdata line Db.

Next, if the signal applied to the first driving gate line TG1 is changed into the gate-off voltage, the signal is not applied to the first subdata line Da connected to the first subpixel electrode PEa, and the second data signal Pb of the data lines D1, D2 is applied to the second subpixel electrodes PEb of the pixels PX of the first pixel row, the first pixel column, and the second pixel column through the second subdata line Db.

That is, after the second subpixel electrode PEb is pre-charged by the first data signal Pa applied to the first subpixel electrode PEa, the second data signal Pb is changed. Also, in the case of the first subpixel electrode PEa, the first gate line G1 is supplied with the gate-on voltage and simultaneously the first data signal Pa is applied such that the charging time of the first data signal Pa is long.

Next, if the gate signal G applied to the first gate line G1 is changed from the gate on signal to the gate off signal and simultaneously the second gate line G2 is supplied with the gate on signal, the switching element connected to the first subpixel electrode PEa and the second subpixel electrodes PEb of the plurality of pixels PX positioned at the second pixel row connected to the first gate line G1 is turned on.

As the second gate line G2 is supplied with the gate-on voltage and simultaneously the first driving gate line TG1 is supplied with the gate-on voltage such that the first driving transistor QT1 is turned on, the first data signal Pa applied to the data lines D1, D2 is applied to the first subpixel electrodes PEa of the pixels PX of the second pixel row, the first pixel column, and the second pixel column through the first subdata line Da. Simultaneously, the first data signal Pa applied to the data lines D1, D2 is applied to the second subpixel electrodes PEb of the pixels PX of the second pixel row, the first pixel column, and the second pixel column through the second subdata line Db.

Next, if the signal applied to the first driving gate line TG1 is changed into the gate-off voltage, the signal is not applied to the first subdata line Da connected to the first subpixel electrode PEa, and the second data signal Pb applied to the data lines D1, D2 is applied to the second subpixel electrodes PEb of the pixels PX of the second pixel row, the first pixel column, and the second pixel column through the second subdata line Db.

This step is sequentially repeated such that the different voltages Pa, Pb are applied to the first subpixel electrode PEa and the second subpixel electrode PEb for each pixel PX of the liquid crystal display. The absolute value of the first data voltage Pa applied to the first subpixel electrode PEa is larger than the absolute value of the second data voltage Pb applied to the second subpixel electrode PEb.

Referring to FIG. 8, the period in which the first driving gate line TG1 is supplied with the gate-on voltage is the initial about half a period of the period 1 H in which the gate lines G1, G2 are supplied with the gate-on signal. Also, the second subpixel electrode PEb is directly connected to the second subdata line Db of the data lines D1, D2 without the second driving transistor QT2. Accordingly, after the second subpixel electrode PEb is pre-charged by the first data signal Pa applied to the first subpixel electrode PEa, the second data signal Pb is charged. Also, in the case of the first subpixel electrode PEa, the first gate line G1 is supplied with the gate-on voltage and simultaneously the first data signal Pa is applied such that the charging time of the first data signal Pa is long.

Therefore, the charging time deterioration of the data voltage charged to the first subpixel electrode PEa and the second subpixel electrode PEb can be prevented.

According to an exemplary embodiment of the present invention, each pixel PX is divided into two subpixel electrodes PEa, PEb. The two subpixel electrodes PEa, PEb are connected to the two subdata lines Da, Db extended from the data lines D1, D2. The desired data voltage is applied by using the data driving switching element QT1 connected to the first subdata line Da of the two subdata lines Da, Db. Thereby, the data voltages of the different magnitudes may be applied to the two subpixel electrodes PEa, PEb while reducing the number of data lines by half. Accordingly, while improving the lateral visibility of the liquid crystal display, the cost of the driver can be reduced and the lack of space to mount the data driver can be prevented.

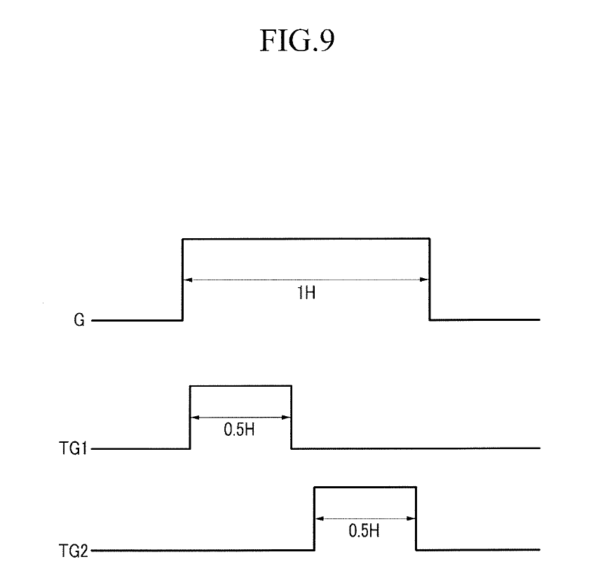

Next, examples of a signal applied to a signal line of liquid crystal displays according to exemplary embodiments of the present invention will be described with reference FIG. 9 to FIG. 11, FIG. 9 to FIG. 11 being waveform diagrams of a signal applied to a signal line of liquid crystal displays according to exemplary embodiments of the present invention.

Firstly, referring to FIG. 9, similar to the exemplary embodiment shown in FIG. 2, the period (0.5 H) in which the first driving gate line TG1 is supplied with the gate-on voltage is half the period 1 H in which the gate lines G1, G2 are supplied with the gate-on signal, and the period (0.5 H) in which the second driving gate line TG2 is supplied with the gate-on voltage is half the period 1 H in which the gate lines G1, G2 are supplied with the gate on-signal. That is, the gate-on voltage is applied to the first driving gate line TG1 during the initial about half a period among the period 1 H in which the gate-on signal is applied to the gate lines G1, G2, and the gate-on voltage is applied to the second driving gate line TG2 during the latter about half a period among the period 1 H in which the gate-on signal is applied to the gate lines G1, G2.

Therefore, the first data voltage Pa is applied to the first subpixel electrode PEa of each pixel PX during the initial about half a period in which the gate on signal is applied among the period 1 H, and is charged to the first subpixel electrode PEa during a period in which the gate-on voltage applied to the gate lines G1, G2 is maintained. On the other hand, the second data voltage Pb is applied to the second subpixel electrode PEb of each pixel PX during the latter about half a period among the period 1 H in which the gate on signal is applied, and is charged to the second subpixel electrode PEb during about half of the period in which the gate-on voltage applied to the gate lines G1, G2 is maintained. As described above, since the absolute value of the first data voltage Pa applied to the first subpixel electrode PEa is larger than the absolute value of the second data voltage Pb applied to the second subpixel electrode PEb, the charging time of the first data voltage Pa having a relatively large absolute value is long and the charging time of the second data voltage Pb having a relatively small absolute value, compared with the case in which the charging time of the first data voltage Pa having the relatively large absolute value, is short, an influence according to the charging time deterioration of the data voltage charged to the second subpixel electrode PEb is decreased.

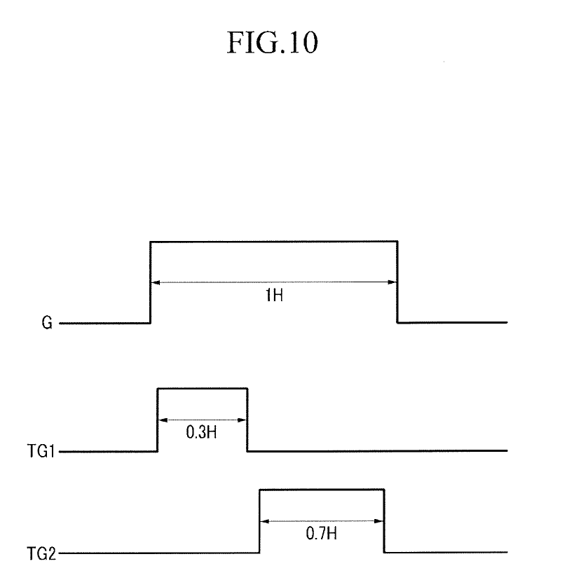

Referring to FIG. 10, the period (0.3 H) in which the first driving gate line TG1 is supplied with the gate-on voltage is the initial about 30% period of the period 1 H in which the gate lines G1, G2 are supplied with the gate-on signal, and the period (0.7 H) in which the second driving gate line TG2 is supplied with the gate-on voltage is the latter about 70% period of the period 1 H in which the gate lines G1, G2 are supplied with the gate-on signal. That is, the gate-on voltage is applied to the first driving gate line TG1 during the initial about 30% period among the period 1 H in which the gate on signal is applied to the gate lines G1, G2, and the gate-on voltage is applied to the second driving gate line TG2 during the latter about 70% period among the period 1 H in which the gate on signal is applied to the gate lines G1, G2.

Therefore, the first data voltage Pa is applied to the first subpixel electrode PEa of each pixel PX during the initial about 30% period in which the gate on signal is applied among the period 1 H, and is charged to the first subpixel electrode PEa during the period in which the gate-on voltage applied to the gate lines G1, G2 is maintained. Also, the second data voltage Pb is applied to the second subpixel electrode PEb of each pixel PX during the latter about 70% period among the period 1 H in which the gate on signal is applied, and is charged to the second subpixel electrode PEb during about 70% period of the period in which the gate-on voltage applied to the gate lines G1, G2 is maintained.

As described above, since the value of the first data voltage Pa applied to the first subpixel electrode PEa is larger than the value of the second data voltage Pb applied to the second subpixel electrode PEb, the charging time of the first data voltage Pa having the large value is long and the charging time of the second data voltage Pb having the small value is short, deterioration of the data voltage charged to the second subpixel electrode PEb may be decreased. Also, since the charging time in which the data voltage is charged to the second subpixel electrode PEb is maintained during about 70% of the period in which the gate-on voltage is maintained, deterioration of the charging time of the second data voltage PB can be prevented.

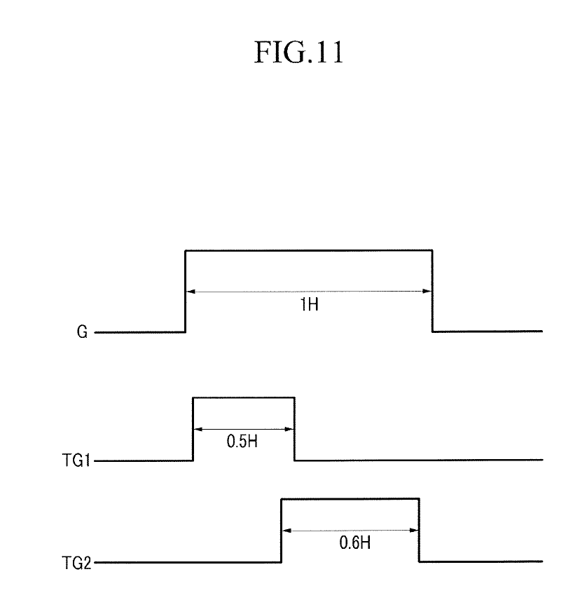

Referring to FIG. 11, a period (0.5 H) in which the first driving gate line TG1 is supplied with the gate-on voltage is the initial 50% period that is half of the period 1 H in which the gate lines G1, G2 are supplied with the gate-on signal, and a period (0.6 H) in which the second driving gate line TG2 is supplied with the gate-on voltage is a latter 60% period of the period 1 H in which the gate lines G1, G2 are supplied with the gate on signal. Also, the period (0.5 H) in which the first driving gate line TG1 is supplied with the gate-on voltage and the period (0.6 H) in which the second driving gate line TG2 is supplied with the gate-on voltage are partially overlapped.

That is, the gate-on voltage is applied to the first driving gate line TG1 during the initial about 50% period among the period 1 H in which the gate-on signal is applied to the gate lines G1, G2, and the gate-on voltage is applied to the second driving gate line TG2 during the latter about 60% period among the period 1 H in which the gate on signal is applied to the gate lines G1, G2.

Therefore, the first data voltage Pa is applied to the first subpixel electrode PEa of each pixel PX during the initial about 50% period in which the gate on signal is applied among the period 1 H, and is charged to the first subpixel electrode PEa during the period in which the gate-on voltage applied to the gate lines G1, G2 is maintained. On the other hand, the second data voltage Pb is applied to the second subpixel electrode PEb of each pixel PX during the latter about 60% period among the period 1 H in which the gate on signal is applied, and is charged to the second subpixel electrode PEb during the about 60% period of the period in which the gate-on voltage applied to the gate lines G1, G2 is maintained. Also, during the partial overlapping period of the period (0.5 H) in which the first driving gate line TG1 is supplied with the gate-on voltage and the period (0.6 H) in which the second driving gate line TG2 is supplied with the gate-on voltage, the second subpixel electrode PEa is pre-charged with the first data voltage Pa and then is charged to the second data voltage Pb.

During the partial overlapping period of the period (0.5 H) in which the first driving gate line TG1 is supplied with the gate-on voltage and the period (0.6 H) in which the second driving gate line TG2 is supplied with the gate-on voltage, by pre-charging the second subpixel electrode PEa with the first data voltage Pa and charging it with the second data voltage Pb, the deterioration of the charging time of the second data voltage PB can be prevented.

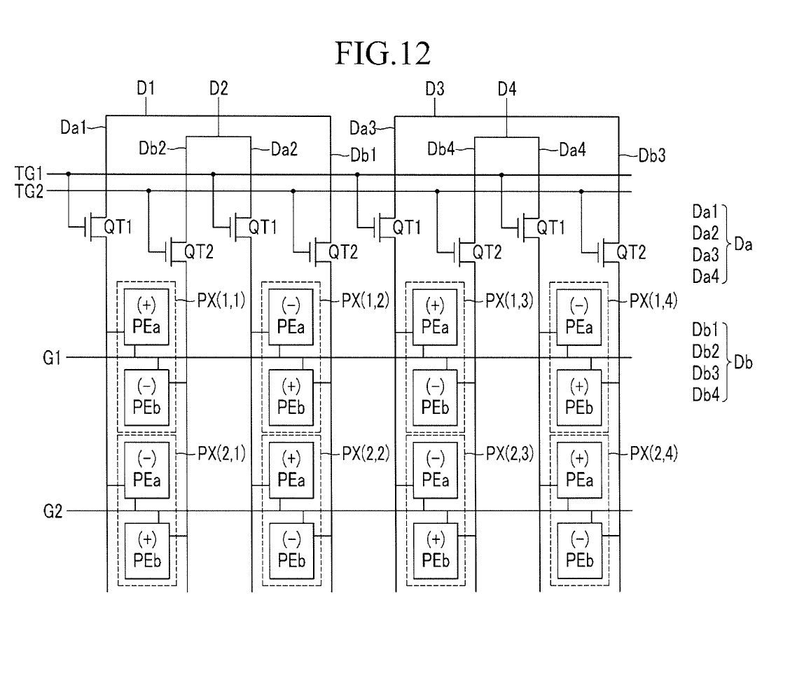

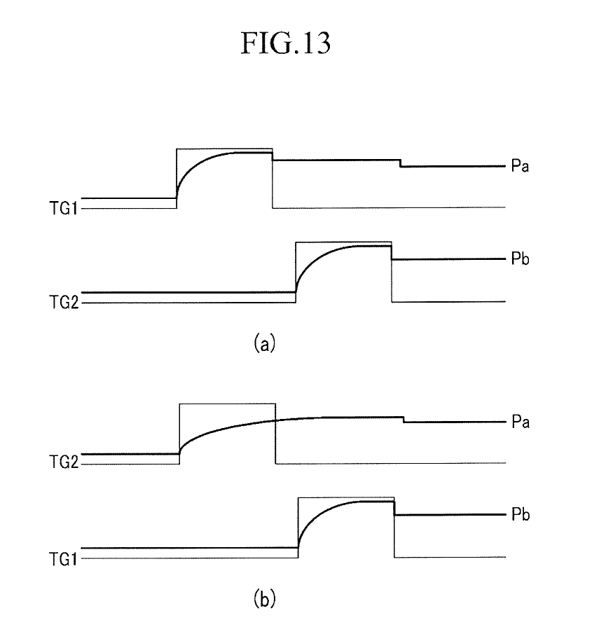

Next, a liquid crystal display and a driving method thereof according to another exemplary embodiment of the present invention will be described with reference to FIG. 12 and FIG. 13, FIG. 12 being a layout view of an arrangement of signal lines and pixels of a liquid crystal display according to another exemplary embodiment of the present invention, and FIG. 13 being a waveform diagram of a signal applied to the signal line of the liquid crystal display of FIG. 12.

Referring to FIG. 12, a liquid crystal display according to an exemplary embodiment of the present invention includes a plurality of gate lines G1, G2 extending in a first direction, a plurality of data lines D1, D2, D3, D4 extending in a second direction, and a plurality of pixels PX connected to the gate lines and the data lines and arranged in a matrix shape. The plurality of pixels PX respectively include a first subpixel electrode PEa and a second subpixel electrode PEb. The liquid crystal display according to the present exemplary embodiment further includes a first driving gate line TG1 and a second driving gate line TG2. Also, the liquid crystal display according to the present exemplary embodiment further includes a first driving transistor QT1 connected to the first driving gate line TG1, the data lines D1, D2, and the first subdata line Da of each data lines D1, D2, and the second driving transistor QT2 connected to the second driving gate line TG2, the data lines D1, D2, and the second subdata line Db of each data line D1, D2.

The first gate line G1 of the plurality of gate lines G1, G2 is connected to a plurality of pixels PX positioned at the first pixel row among the plurality of pixels, and the second gate line G2 is connected to a plurality of pixels PX positioned at the second pixel row adjacent to the first pixel row among the plurality of pixels PX.

The plurality of data lines D1, D2, D3, D4 respectively include a first subdata line Da and a second subdata line Db.

Among the plurality of data lines D1, D2, D3, D4, a second subdata line Db2 of the second data line D2 is positioned close to a first subdata line Da1 of the first data line D1. A first subdata line Da2 of the second data line D2 is positioned close to the second subdata line Db2 of the second data line D2. A second subdata line Db1 of the first data line D1 is positioned close to the first subdata line Da2 of the second data line D2. Similarly, among the plurality of data lines D1, D2, D3, D4, a second subdata line Db4 of the fourth data line D4 is positioned close to a first subdata line Da3 of the third data line D3. A first subdata line Da4 of the fourth data line D4 is positioned close to the second subdata line Db4 of the fourth data line D4. A second subdata line Db3 of the third data line D3 is positioned close to the first subdata line Da4 of the fourth data line D4.

Among the plurality of data lines D1, D2, D3, D4, the first subdata line Da1 of the first data line D1 is connected to the first subpixel electrode PEa of the pixel PX positioned at the first pixel row and the first pixel column among the plurality of pixels PX, and the second subdata line Db1 of the first data line D1 is connected to the second subpixel electrode PEb of the pixel PX positioned at the first pixel row and the second pixel column. Among the plurality of data lines D1, D2, D3, D4, the first subdata line Da2 of the second data line D2 is connected to the first subpixel electrode PEa of the pixel PX positioned at the first pixel row and the second pixel column, and among the plurality of data lines D1, D2, D3, D4, the second subdata line Db2 of the second data line D2 is connected to the second subpixel electrode PEb of the pixel PX positioned at the first pixel row and the first pixel column. Similarly, among the plurality of data lines D1, D2, D3, D4, the first subdata line Da3 of the third data line D3 is connected to the first subpixel electrode PEa of the pixel PX positioned at the first pixel row and the third pixel column among the plurality of pixels PX, and the second subdata line Db3 of the third data line D3 is connected to the second subpixel electrode PEb of the pixel PX positioned at the first pixel row and the fourth pixel column. Among the plurality of data lines D1, D2, D3, D4, the first subdata line Da4 of the fourth data line D4 is connected to the first subpixel electrode PEa of the pixel PX positioned at the first pixel row and the fourth pixel column, and among the plurality of data lines D1, D2, D3, D4, the second subdata line Db4 of the fourth data line D4 is connected to the second subpixel electrode PEb of the pixel PX positioned at the first pixel row and the third pixel column.

In the case of the second pixel row, the connection relation between the first subdata line Da and the second subdata line Db, and between the first subpixel electrode PEa and the second subpixel electrode PEb, is opposite to the first pixel row.

In more detail, among the plurality of data lines D1, D2, D3, D4, the first subdata line Da1 of the first data line D1 is connected to the second subpixel electrode PEb of the pixel PX positioned at the second pixel row and the first pixel column among the plurality of pixels PX, and the second subdata line Db1 of the first data line D1 is connected to the first subpixel electrode PEa of the pixel PX positioned at the second pixel row and the second pixel column. Among the plurality of data lines D1, D2, D3, D4, the first subdata line Da2 of the second data line D2 is connected to the second subpixel electrode PEb of the pixel PX positioned at the second pixel row and the second pixel column, and among the plurality of data lines D1, D2, D3, D4, the second subdata line Db2 of the second data line D2 is connected to the first subpixel electrode PEa of the pixel PX positioned at the second pixel row and the first pixel column. Similarly, among the plurality of data lines D1, D2, D3, D4, the first subdata line Da3 of the third data line D3 is connected to the second subpixel electrode PEb of the pixel PX positioned at the second pixel row and the third pixel column among a plurality of pixels PX, and the second subdata line Db3 of the third data line D3 is connected to the first subpixel electrode PEa of the pixel PX positioned at the second pixel row and the fourth pixel column. Among the plurality of data lines D1, D2, D3, D4, the first subdata line Da4 of the fourth data line D4 is connected to the second subpixel electrode PEb of the pixel PX positioned at the second pixel row and the fourth pixel column, and among the plurality of data lines D1, D2, D3, D4, the second subdata line Db4 of the fourth data line D4 is connected to the first subpixel electrode PEa of the pixel PX positioned at the second pixel row and the third pixel column.

Although not shown, the first subpixel electrode PEa of each pixel PX is connected to the gate lines G1, G2 and the first subdata line Da of the data lines D1, D2 through a switching element such as a thin film transistor, and the second subpixel electrode PEb of each pixel PX is connected to the gate lines G1, G2 and the second subdata line Db of the data lines D1, D2 through the switching element such as the thin film transistor.

Referring to FIG. 13 along with FIG. 12, as the gate-on voltage is applied to the first gate line G1 and simultaneously the gate-on voltage is also applied to the first driving gate line TG1 such that the first driving transistor QT1 is turned on, the first data voltage Pa is applied to the first subpixel electrode PEa of the pixel PX positioned at the first pixel row and the first pixel column through the first subdata line Da1 of the first data line D1. The first data voltage Pa is applied to the first subpixel electrode PEa of the pixel PX positioned at the first pixel row and the second pixel column through the first subdata line Da2 of the second data line D2. The first data voltage Pa is applied to the first subpixel electrode PEa of the pixel PX positioned at the first pixel row and the third pixel column through the first subdata line Da3 of the third data line D3. The first data voltage Pa is applied to the first subpixel electrode PEa of the pixel PX positioned at the first pixel row and the fourth pixel column through the first subdata line Da4 of the fourth data line D4. Next, if the signal TG1 applied to the first driving gate line TG1 is changed into the gate-off signal and the signal TG2 applied to the second driving gate line TG2 is changed into the gate-on signal, the second driving transistor QT2 is turned on such that the second data voltage Pb is applied to the second subpixel electrode PEb of the pixel PX positioned at the first pixel row and the second pixel column through the second subdata line Db1 of the first data line D1. The second data voltage Pb is applied to the second subpixel electrode PEb of the pixel PX positioned at the first pixel row and the first pixel column through the second subdata line Db2 of the second data line D2. The second data voltage Pb is applied to the second subpixel electrode PEb of the pixel PX positioned at the first pixel row and the fourth pixel column through the second subdata line Db3 of the third data line D3. The second data voltage Pb is applied to the second subpixel electrode PEb of the pixel PX positioned at the first pixel row and the third pixel column through the second subdata line Db4 of the fourth data line D4.

Next, the signal applied to the first gate line G1 is changed into the gate-off signal, and the signal applied to the second gate line G2 is changed into the gate-on signal. The second gate line G2 is supplied with the gate-on signal and simultaneously the second driving gate line TG2 is supplied with the gate-on voltage such that the second driving transistor QT2 is turned on. The first data voltage Pa is applied to the first subpixel electrode PEa of the pixel PX positioned at the second pixel row and the second pixel column through the second subdata line Db1 of the first data line D1. The first data voltage Pa is applied to the first subpixel electrode PEa of the pixel PX positioned at the second pixel row and the first pixel column through the second subdata line Db2 of the second data line D2. The first data voltage Pa is applied to the first subpixel electrode PEa of the pixel PX positioned at the second pixel row and the fourth pixel column through the second subdata line Db3 of the third data line D3. The first data voltage Pa is applied to the first subpixel electrode PEa of the pixel PX positioned at the second pixel row and the third pixel column through the second subdata line Db4 of the fourth data line D4.

Next, if the signal TG2 applied to the first driving gate line TG2 is changed into the gate-off signal and the signal TG1 applied to the first driving gate line TG1 is changed into the gate-on signal, the first driving transistor QT1 is turned on such that the second data voltage Pb is applied to the second subpixel electrode PEb of the pixel PX positioned at the second pixel row and the first pixel column through the first subdata line Da of the first data line D1. The second data voltage Pb is applied to the first subpixel electrode PEa of the pixel PX positioned at the second pixel row and the first pixel column through the second subdata line Db2 of the second data line D2. The second data voltage Pb is applied to the first subpixel electrode PEa of the pixel PX positioned at the second pixel row and the fourth pixel column through the second subdata line Db3 of the third data line D3. The second data voltage Pb is applied to the first subpixel electrode PEa of the pixel PX positioned at the second pixel row and the third pixel column through the second subdata line Db4 of the fourth data line D4.

According to the liquid crystal display and the driving method according to the exemplary embodiment shown in FIG. 12 and FIG. 13, although the data voltage applied through the first subdata lines Da1, Da3 of the first data line D1 and the third data line D3 has the positive polarity (+), the data voltage applied through the second subdata lines Db1, Db3 applied through the first data line D1 and the third data line D3 has the negative polarity (−). The data voltage applied through the first subdata lines Da2, Da4 of the second data line D2 and the fourth data line D4 has the negative polarity (−), and the data voltage applied through the second subdata lines Db2, Db4 of the second data line D1 and the fourth data line D4 has the positive polarity (+). The polarity of each pixel PX may be determined through dot inversion. That is, while the data lines D1, D2, D3, and D4 are driven with the column inversion, the polarity of each pixel PX may be determined through dot inversion.

According to the liquid crystal display according to the present exemplary embodiment, the pixel PX is divided into two subpixel electrodes PEa, PEb, the two subpixel electrodes PEa, PEb are respectively connected to two subdata lines Da, Db extended from the data lines D1, D2, D3, D4, and the data voltage is applied by using the data driving switching element QT2 connected to the second subdata line Db of two subdata lines Da, Db. Thereby, the data voltages of the different magnitudes may be applied to the two subpixel electrodes PEa, PEb while reducing the number of data lines by half. Accordingly, while improving the lateral visibility of the liquid crystal display, the cost of the driver can be reduced and the lack of space to mount the data driver can be prevented.

Also, while the data lines D1, D2, D3, D4 are driven with the column inversion, the polarity of each pixel PX may be determined through dot inversion.

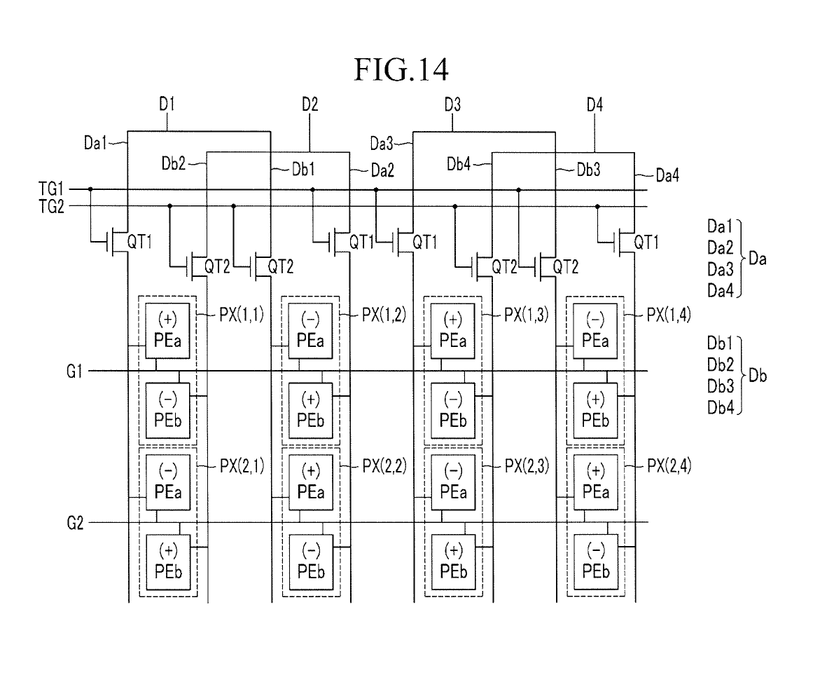

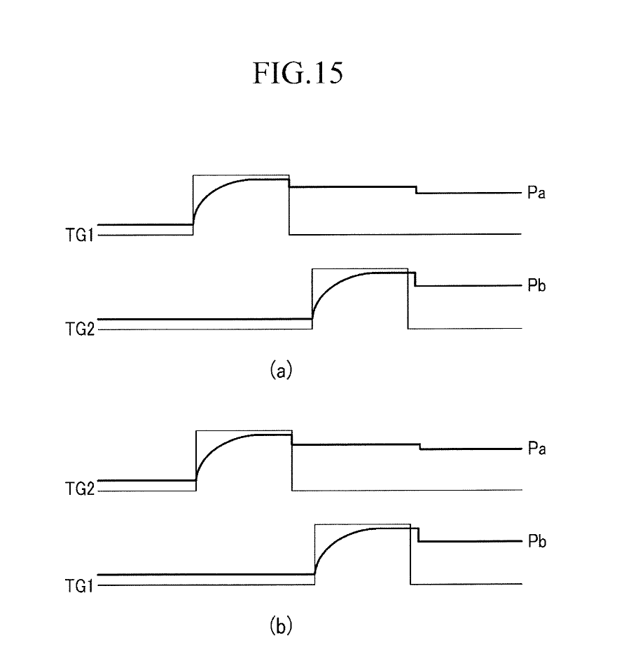

Next, a liquid crystal display and a driving method thereof according to another exemplary embodiment of the present invention will be described with reference to FIG. 14 and FIG. 15, FIG. 14 being a layout view of an arrangement of a signal line and a pixel of a liquid crystal display according to another exemplary embodiment of the present invention, and FIG. 15 being a waveform diagram of a signal applied to the signal line of the liquid crystal display of FIG. 14.

Firstly, referring to FIG. 14, the liquid crystal display according to the present exemplary embodiment is similar to the liquid crystal display according to the exemplary embodiment shown in FIG. 12.

However, in the liquid crystal display according to the present exemplary embodiment, is different from the liquid crystal display according to the exemplary embodiment shown in FIG. 12, in that among a plurality of data lines D1, D2, D3, D4, a second subdata line Db2 of the second data line D2 is positioned close to a first subdata line Da1 of the first data line D1, a second subdata line Db1 of the first data line D1 is positioned close to the second subdata line Db2 of the second data line D2, and a first subdata line Da2 of the second data line D1 is positioned close to the second subdata line Db1 of the first data line D1. Similarly, among the plurality of data lines D1, D2, D3, D4, a second subdata line Db4 of the fourth data line D4 is positioned close to a first subdata line Da3 of the third data line D3, a second subdata line Db3 of the third data line D3 is positioned close to the second subdata line Db4 of the fourth data line D4, and a first subdata line Da4 of the fourth data line D4 is positioned close to the second subdata line Db3 of the third data line D3.

The connection relation between the signal and the pixel according to the present exemplary embodiment is similar to the liquid crystal display according to the exemplary embodiment shown in FIG. 12. In more detail, among the plurality of data lines D1, D2, D3, D4, the first subdata line Da1 of the first data line D1 is connected to the first subpixel electrode PEa of the pixel PX positioned at the first pixel row and the first pixel column among the plurality of pixels PX, and the second subdata line Db1 of the first data line D1 is connected to the second subpixel electrode PEb of the pixel PX positioned at the first pixel row and the second pixel column. Among the plurality of data lines D1, D2, D3, D4, the first subdata line Da2 of the second data line D2 is connected to the first subpixel electrode PEa of the pixel PX positioned at the first pixel row and the second pixel column, and among the plurality of data lines D1, D2, D3, D4, the second subdata line Db2 of the second data line D2 is connected to the second subpixel electrode PEb of the pixel PX positioned at the first pixel row and the first pixel column. Similarly, among the plurality of data lines D1, D2, D3, D4, the first subdata line Da3 of the third data line D3 is connected to the first subpixel electrode PEa of the pixel PX positioned at the first pixel row and the third pixel column among the plurality of pixels PX, and the second subdata line Db3 of the third data line D3 is connected to the second subpixel electrode PEb of the pixel PX positioned at the first pixel row and the fourth pixel column. Among the plurality of data lines D1, D2, D3, D4, the first subdata line Da4 of the fourth data line D4 is connected to the first subpixel electrode PEa of the pixel PX positioned at the first pixel row and the fourth pixel column, and among the plurality of data lines D1, D2, D3, D4, the second subdata line Db4 of the fourth data line D4 is connected to the second subpixel electrode PEb of the pixel PX positioned at the first pixel row and the third pixel column.

In the case of the second pixel row, the connection relation between the first subdata line Da and the second subdata line Db, and between the first subpixel electrode PEa and the second subpixel electrode PEb, is opposite to the first pixel row.

In more detail, among the plurality of data lines D1, D2, D3, D4, the first subdata line Da1 of the first data line D1 is connected to the second subpixel electrode PEb of the pixel PX positioned at the second pixel row and the first pixel column among the plurality of pixels PX, and the second subdata line Db1 of the first data line D1 is connected to the first subpixel electrode PEa of the pixel PX positioned at the second pixel row and the second pixel column. Among the plurality of data lines D1, D2, D3, D4, the first subdata line Da2 of the second data line D2 is connected to the second subpixel electrode PEb of the pixel PX positioned at the second pixel row and the second pixel column, among the plurality of data lines D1, D2, D3, D4, the second subdata line Db2 of the second data line D2 is connected to the first subpixel electrode PEa of the pixel PX positioned at the second pixel row and the first pixel column. Similarly, among the plurality of data lines D1, D2, D3, D4, the first subdata line Da3 of the third data line D3 is connected to the second subpixel electrode PEb of the pixel PX positioned at the second pixel row and the third pixel column among the plurality of pixels PX, and the second subdata line Db3 of the third data line D3 is connected to the first subpixel electrode PEa of the pixel PX positioned at the second pixel row and the fourth pixel column. Among the plurality of data lines D1, D2, D3, D4, the first subdata line Da4 of the fourth data line D4 is connected to the second subpixel electrode PEb of the pixel PX positioned at the second pixel row and the fourth pixel column, and among the plurality of data lines D1, D2, D3, D4, the second subdata line Db4 of the fourth data line D4 is connected to the first subpixel electrode PEa of the pixel PX positioned at the second pixel row and the third pixel column.

Although not shown, the first subpixel electrode PEa of each pixel PX is connected to gate lines G1, G2 and a first subdata line Da of the data lines D1, D2 through a switching element such as a thin film transistor, and the second subpixel electrode PEb of each pixel PX is connected to the gate lines G1, G2 and a second subdata line Db of the data lines D1, D2 through the switching element such as the thin film transistor.

Referring to FIG. 15 along with FIG. 14, as the gate-on voltage is applied to the first gate line G1 and simultaneously the gate-on voltage is also applied to the first driving gate line TG1 such that the first driving transistor QT1 is turned on, the first data voltage Pa is applied to the first subpixel electrode PEa of the pixel PX positioned at the first pixel row and the first pixel column through the first subdata line Da1 of the first data line D1. The first data voltage Pa is applied to the first subpixel electrode PEa of the pixel PX positioned at the first pixel row and the second pixel column through the first subdata line Da2 of the second data line D2. The first data voltage Pa is applied to the first subpixel electrode PEa of the pixel PX positioned at the first pixel row and the third pixel column through the first subdata line Da3 of the third data line D3. The first data voltage Pa is applied to the first subpixel electrode PEa of the pixel PX positioned at the first pixel row and the fourth pixel column through the first subdata line Da4 of the fourth data line D4. Next, if the signal TG1 applied to the first driving gate line TG1 is changed into the gate-off signal and the signal TG2 applied to the second driving gate line TG2 is changed into the gate-on signal, the second driving transistor QT2 is turned on such that the second data voltage Pb is applied to the second subpixel electrode PEb of the pixel PX positioned at the first pixel row and the second pixel column through the second subdata line Db1 of the first data line D1. The second data voltage Pb is applied to the second subpixel electrode PEb of the pixel PX positioned at the first pixel row and the first pixel column through the second subdata line Db2 of the second data line D2. The second data voltage Pb is applied to the second subpixel electrode PEb of the pixel PX positioned at the first pixel row and the fourth pixel column through the second subdata line Db3 of the third data line D3. The second data voltage Pb is applied to the second subpixel electrode PEb of the pixel PX positioned at the first pixel row and the third pixel column through the second subdata line Db4 of the fourth data line D4.

Next, the signal applied to the first gate line G1 is changed into the gate-off signal, and the signal applied to the second gate line G2 is changed into the gate-on signal. The second gate line G2 is supplied with the gate-on signal and simultaneously the second driving gate line TG2 is supplied with the gate-on voltage such that the second driving transistor QT2 is turned on, the first data voltage Pa is applied to the first subpixel electrode PEa of the pixel PX positioned at the second pixel row and the second pixel column through the second subdata line Db1 of the first data line D1. The first data voltage Pa is applied to the first subpixel electrode PEa of the pixel PX positioned at the second pixel row and the first pixel column through the second subdata line Db2 of the second data line D2. The first data voltage Pa is applied to the first subpixel electrode PEa of the pixel PX positioned at the second pixel row and the fourth pixel column through the second subdata line Db3 of the third data line D3. The first data voltage Pa is applied to the first subpixel electrode PEa of the pixel PX positioned at the second pixel row and the third pixel column through the second subdata line Db4 of the fourth data line D4.

Next, if the signal TG2 applied to the first driving gate line TG2 is changed into the gate-off signal and the signal TG1 applied to the first driving gate line TG1 is changed into the gate-on signal, the first driving transistor QT1 is turned on such that the second data voltage Pb is applied to the second subpixel electrode PEb of the pixel PX positioned at the second pixel row and the first pixel column through the first subdata line Da of the first data line D1. The second data voltage Pb is applied to the first subpixel electrode PEa of the pixel PX positioned at the second pixel row and the first pixel column through the second subdata line Db2 of the second data line D2. The second data voltage Pb is applied to the first subpixel electrode PEa of the pixel PX positioned at the second pixel row and the fourth pixel column through the second subdata line Db3 of the third data line D3. The second data voltage Pb is applied to the first subpixel electrode PEa of the pixel PX positioned at the second pixel row and the third pixel column through the second subdata line Db4 of the fourth data line D4.

According to the liquid crystal display and the driving method according to the exemplary embodiment shown in FIG. 14 and FIG. 15, although the data voltage applied through the first subdata lines Da1, Da3 of the first data line D1 and the third data line D3 has the positive polarity (+), the data voltage applied through the second subdata lines Db1, Db3 applied through the first data line D1 and the third data line D3 has the negative polarity (−). The data voltage applied through the first subdata lines Da2, Da4 of the second data line D2 and the fourth data line D4 has the negative polarity (−). The data voltage applied through the second subdata lines Db2 and Db4 of the second data line D1 and the fourth data line D4 has the positive polarity (+). The polarity of each pixel PX may be determined through dot inversion. That is, while the data lines D1, D2, D3, D4 are driven with the column inversion, the polarity of each pixel PX may determined through dot inversion.

According to the liquid crystal display according to the present exemplary embodiment, each pixel PX is divided into two subpixel electrodes PEa, PEb, the two subpixel electrodes PEa, PEb are respectively connected to the two subdata lines Da, Db extended from the data lines D1, D2, D3, D4, and the data voltage is applied by using the data driving switching element QT2 connected to the second subdata line Db of the two subdata lines Da, Db. Thereby, the data voltages of different magnitudes may be applied to the two subpixel electrodes PEa, PEb while reducing the number of data lines by half. Accordingly, while improving the lateral visibility of the liquid crystal display, the cost of the driver can be reduced and the lack of space to mount the data driver can be prevented.

Also, while the data lines D1, D2, D3, D4 are driven with the column inversion, the polarity of each pixel PX may be determined through dot inversion.

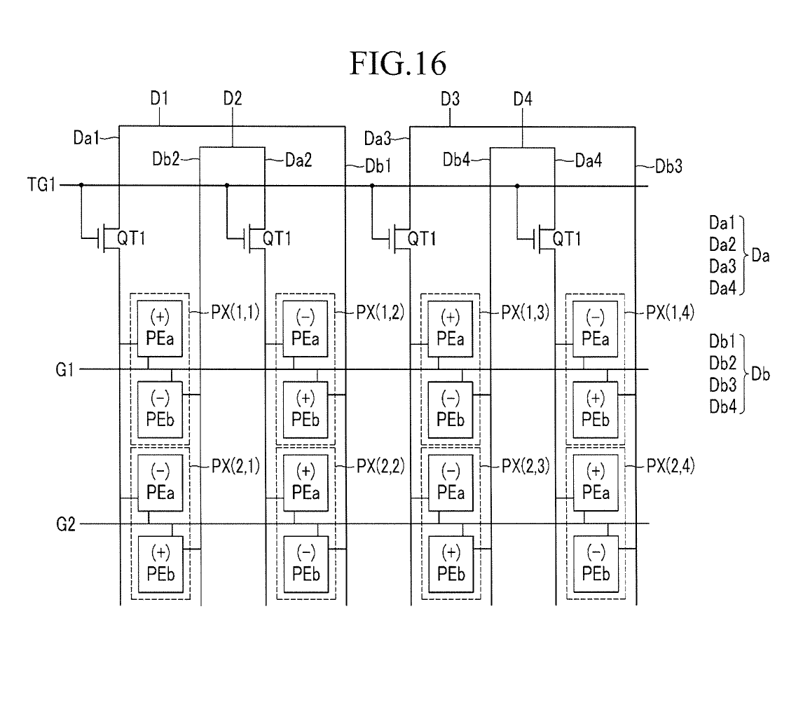

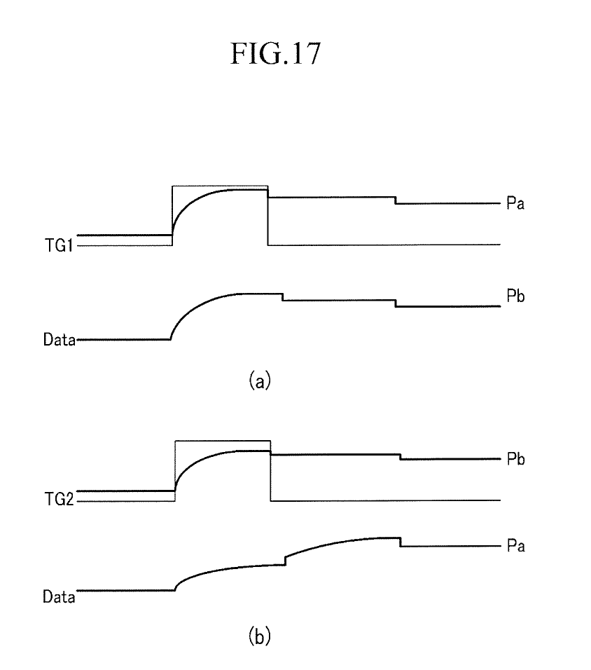

Next, a liquid crystal display and a driving method thereof according to another exemplary embodiment of the present invention will be described with reference to FIG. 16 and FIG. 17, FIG. 16 being a layout view of an arrangement of a signal line and a pixel of a liquid crystal display according to another exemplary embodiment of the present invention, and FIG. 17 being a waveform diagram of a signal applied to the signal line of the liquid crystal display of FIG. 16.

Firstly, referring to FIG. 16, the liquid crystal display according to the present exemplary embodiment is similar to the liquid crystal display according to the exemplary embodiment shown in FIG. 12.

However, the liquid crystal display according to the present exemplary embodiment, is different from the liquid crystal display according to the exemplary embodiment shown in FIG. 12, in that a second driving gate line TG2 and a second driving transistor QT2 connected to a second subdata line Db of a plurality of data lines D1, D2, D3, D4 are not included.

In more detail, a liquid crystal display according to the present exemplary embodiment includes a plurality of gate lines G1, G2 extending in a first direction, a plurality of data lines D1, D2 extending in the second direction, and a plurality of pixels PX connected to the gate lines and the data lines and arranged in a matrix shape.

The first gate line G1 of the plurality of gate lines G1, G2 is connected to a plurality of pixels PX positioned at the first pixel row among the plurality of pixels PX, and the second gate line G2 is connected to a plurality of pixels PX positioned at the second pixel row adjacent to the first pixel row among the plurality of pixels PX.

The plurality of pixels PX respectively include a first subpixel electrode PEa and a second subpixel electrode PEb.

The plurality of data lines D1, D2, D3, D4 respectively include a first subdata line Da and the second subdata line Db.

Among the plurality of data lines D1, D2, D3, D4, a second subdata line Db2 of the second data line D2 is positioned close to a first subdata line Da1 of the first data line D1. A first subdata line Da2 of the second data line D2 is positioned close to the second subdata line Db2 of the second data line D2. A second subdata line Db1 of the first data line D1 is positioned close to the first subdata line Da2 of the second data line D2. Similarly, among the plurality of data lines D1, D2, D3, D4, a second subdata line Db4 of the fourth data line D4 is positioned close to a first subdata line Da3 of the third data line D3. A first subdata line Da4 of the fourth data line D4 is positioned close to the second subdata line Db4 of the fourth data line D4. A second subdata line Db3 of the third data line D3 is positioned close to the first subdata line Da4 of the fourth data line D4.

Among the plurality of data lines D1, D2, D3, D4, the first subdata line Da1 of the first data line D1 is connected to the first subpixel electrode PEa of the pixel PX positioned at the first pixel row and the first pixel column among the plurality of pixels PX, and the second subdata line Db1 of the first data line D1 is connected to the second subpixel electrode PEb of the pixel PX positioned at the first pixel row and the second pixel column. Among the plurality of data lines D1, D2, D3, D4, the first subdata line Da2 of the second data line D2 is connected to the first subpixel electrode PEa of the pixel PX positioned at the first pixel row and the second pixel column, and among the plurality of data lines D1, D2, D3, D4, the second subdata line Db2 of the second data line D2 is connected to the second subpixel electrode PEb of the pixel PX positioned at the first pixel row and the first pixel column. Similarly, among the plurality of data lines D1, D2, D3, D4, the first subdata line Da3 of the third data line D3 is connected to the first subpixel electrode PEa of the pixel PX positioned at the first pixel row and the third pixel column among the plurality of pixels PX, and the second subdata line Db3 of the third data line D3 is connected to the second subpixel electrode PEb of the pixel PX positioned at the first pixel row and the fourth pixel column. Among the plurality of data lines D1, D2, D3, D4, the first subdata line Da4 of the fourth data line D4 is connected to the first subpixel electrode PEa of the pixel PX positioned at the first pixel row and the fourth pixel column, and among the plurality of data lines D1, D2, D3, D4, the second subdata line Db4 of the fourth data line D4 is connected to the second subpixel electrode PEb of the pixel PX positioned at the first pixel row and the third pixel column.

In the case of the second pixel row, the connection relation between the first subdata line Da and the second subdata line Db, and between the first subpixel electrode PEa and the second subpixel electrode PEb, is opposite to the first pixel row.

In more detail, among the plurality of data lines D1, D2, D3, D4, the first subdata line Da1 of the first data line D1 is connected to the second subpixel electrode PEb of the pixel PX positioned at the second pixel row and the first pixel column among the plurality of pixels PX, and the second subdata line Db1 of the first data line D1 is connected to the first subpixel electrode PEa of the pixel PX positioned at the second pixel row and the second pixel column. Among the plurality of data lines D1, D2, D3, D4, the first subdata line Da2 of the second data line D2 is connected to the second subpixel electrode PEb of the pixel PX positioned at the second pixel row and the second pixel column, and among the plurality of data lines D1, D2, D3, D4, the second subdata line Db2 of the second data line D2 is connected to the first subpixel electrode PEa of the pixel PX positioned at the second pixel row and the first pixel column. Similarly, among the plurality of data lines D1, D2, D3, D4, the first subdata line Da3 of the third data line D3 is connected to the second subpixel electrode PEb of the pixel PX positioned at the second pixel row and the third pixel column among the plurality of pixels PX, and the second subdata line Db3 of the third data line D3 is connected to the first subpixel electrode PEa of the pixel PX positioned at the second pixel row and the fourth pixel column. Among the plurality of data lines D1, D2, D3, D4, the first subdata line Da4 of the fourth data line D4 is connected to the second subpixel electrode PEb of the pixel PX positioned at the second pixel row and the fourth pixel column, and among the plurality of data lines D1, D2, D3, D4, the second subdata line Db4 of the fourth data line D4 is connected to the first subpixel electrode PEa of the pixel PX positioned at the second pixel row and the third pixel column.

Although not shown, the first subpixel electrode PEa of each pixel PX is connected to the gate lines G1, G2 and the first subdata line Da of the data lines D1, D2 through a switching element such as a thin film transistor, and the second subpixel electrode PEb of each pixel PX is connected to the gate lines G1, G2 and the second subdata line Db of the data lines D1, D2 through the switching element such as the thin film transistor.

Referring to FIG. 17 along with FIG. 16, as the gate-on voltage is applied to the first gate line G1 and simultaneously the gate-on voltage is also applied to the first driving gate line TG1 such that the first driving transistor QT1 is turned on. The first data voltage Pa is applied to the first subpixel electrode PEa of the pixel PX positioned at the first pixel row and the first pixel column through the first subdata line Da1 of the first data line D1. The first data voltage Pa is applied to the first subpixel electrode PEa of the pixel PX positioned at the first pixel row and the second pixel column through the first subdata line Da2 of the second data line D2. The first data voltage Pa is applied to the first subpixel electrode PEa of the pixel PX positioned at the first pixel row and the third pixel column through the first subdata line Da3 of the third data line D3, and the first data voltage Pa is applied to the first subpixel electrode PEa of the pixel PX positioned at the first pixel row and the fourth pixel column through the first subdata line Da4 of the fourth data line D4. Simultaneously, the first data voltage Pa is applied to the second subpixel electrode PEb of the pixel PX positioned at the first pixel row and the second pixel column through the second subdata line Db1 of the first data line D1, the first data voltage Pa is applied to the second subpixel electrode PEb of the pixel PX positioned at the first pixel row and the first pixel column through the second subdata line Db2 of the second data line D2, the first data voltage Pa is applied to the second subpixel electrode PEb of the pixel PX positioned at the first pixel row and the fourth pixel column through the second subdata line Db3 of the third data line D3, and the first data voltage Pa is applied to the second subpixel electrode PEb of the pixel PX positioned at the first pixel row and the third pixel column through the second subdata line Db4 of the fourth data line D4.

Next, if the signal TG1 applied to the first driving gate line TG1 is changed into the gate-off signal, the signal is not applied to the first subdata line Da connected thereto. The second data signal Pb applied to the data lines D1, D2, D3, D4 is applied to the second subpixel electrode PEb of the pixel PX positioned at the first pixel row and the second pixel column through the second subdata line Db1 of the first data line D1, is applied to the second subpixel electrode PEb of the pixel PX positioned at the first pixel row and the first pixel column through the second subdata line Db2 of the second data line D2, is applied to the second subpixel electrode PEb of the pixel PX positioned at the first pixel row and the fourth pixel column through the second subdata line Db3 of the third data line D3, and is applied to the second subpixel electrode PEb of the pixel PX positioned at the first pixel row and the third pixel column through the second subdata line Db4 of the fourth data line D4.

Next, the signal applied to the first gate line G1 is changed into the gate-off signal, and the signal applied to the second gate line G2 is changed into the gate-on signal. The second gate line G2 is supplied with the gate-on signal and simultaneously the first driving gate line TG1 is also supplied with the gate-on voltage such that the first driving transistor QT1 is turned on, the second data voltage Pb is applied to the second subpixel electrode PEb of the pixel PX positioned at the second pixel row and the first pixel column through the first subdata line Da1 of the first data line D1, the second data voltage Pb is applied to the first subpixel electrode PEa of the pixel PX positioned at the second pixel row and the first pixel column through the second subdata line Db2 of the second data line D2, the second data voltage Pb is applied to the first subpixel electrode PEa of the pixel PX positioned at the second pixel row and the fourth pixel column through the second subdata line Db3 of the third data line D3, and the second data voltage Pb is applied to the first subpixel electrode PEa of the pixel PX positioned at the second pixel row and the third pixel column through the second subdata line Db4 of the fourth data line D4. Simultaneously, the second data voltage Pb is applied to the first subpixel electrode PEa of the pixel PX positioned at the second pixel row and the second pixel column through the second subdata line Db1 of the first data line D1, the second data voltage Pb is applied to the first subpixel electrode PEa of the pixel PX positioned at the second pixel row and the first pixel column through the second subdata line Db2 of the second data line D2, the second data voltage Pb is applied to the first subpixel electrode PEa of the pixel PX positioned at the second pixel row and the fourth pixel column through the second subdata line Db3 of the third data line D3, and the second data voltage Pb is applied to the first subpixel electrode PEa of the pixel PX positioned at the second pixel row and the third pixel column through the second subdata line Db4 of the fourth data line D4.

Next, if the signal TG2 applied to the first driving gate line TG2 is changed into the gate-off signal, the signal is not applied to the first subdata line Da connected thereto, the first data voltage Pa applied to the data lines D1, D2, D3, D4 is applied to the pixel PX positioned at the second pixel row and the second pixel column through the second subdata line Db1 of the first data line D1, is applied to the first subpixel electrode PEa of the pixel PX positioned at the second pixel row and the first pixel column through the second subdata line Db2 of the second data line D2, is applied to the first subpixel electrode PEa of the pixel PX positioned at the second pixel row and the fourth pixel column through the second subdata line Db3 of the third data line D3, and is applied to the first subpixel electrode PEa of the pixel PX positioned at the second pixel row and the third pixel column through the second subdata line Db4 of the fourth data line D4.

According to the liquid crystal display and the driving method according to the exemplary embodiment shown in FIG. 16 and FIG. 17, although the data voltage applied through the first subdata lines Da1, Da3 of the first data line D1 and the third data line D3 has the positive polarity (+), the data voltage applied through the second subdata lines Db1, Db3 applied through the first data line D1 and the third data line D3 has the negative polarity (−), the data voltage applied through the first subdata lines Da2, Da4 of the second data line D2 and the fourth data line D4 has the negative polarity (−), and the data voltage applied through the second subdata lines Db2, Db4 of the second data line D1 and the fourth data line D4 has the positive polarity (+), the polarity of each pixel PX may be determined through dot inversion. That is, while the data lines D1, D2, D3, D4 are driven with the column inversion, the polarity of each pixel PX may be determined through dot inversion.

According to the liquid crystal display according to the present exemplary embodiment, each pixel PX is divided into two subpixel electrodes PEa, PEb, the two subpixel electrodes PEa, PEb are respectively connected to the two subdata lines Da, Db extended from the data lines D1, D2, D3, D4, and the data voltage is applied by using the data driving switching element QT2 connected to the second subdata line Db of the two subdata lines Da, Db. Thereby, the data voltages of the different magnitudes may be applied to the two subpixel electrodes PEa, PEb while reducing the number of data lines by half. Accordingly, while improving the lateral visibility of the liquid crystal display, the cost of the driver can be reduced and the lack of space to mount the data driver can be prevented.

Also, while the data lines D1, D2, D3, D4 are driven with the column inversion, the polarity of each pixel PX may be determined through dot inversion. Further, the subpixel electrode that is secondly charged is pre-charged with the data voltage applied to the subpixel electrode that is firstly charged, and then is currently charged such that the charging time of the data signal is long.

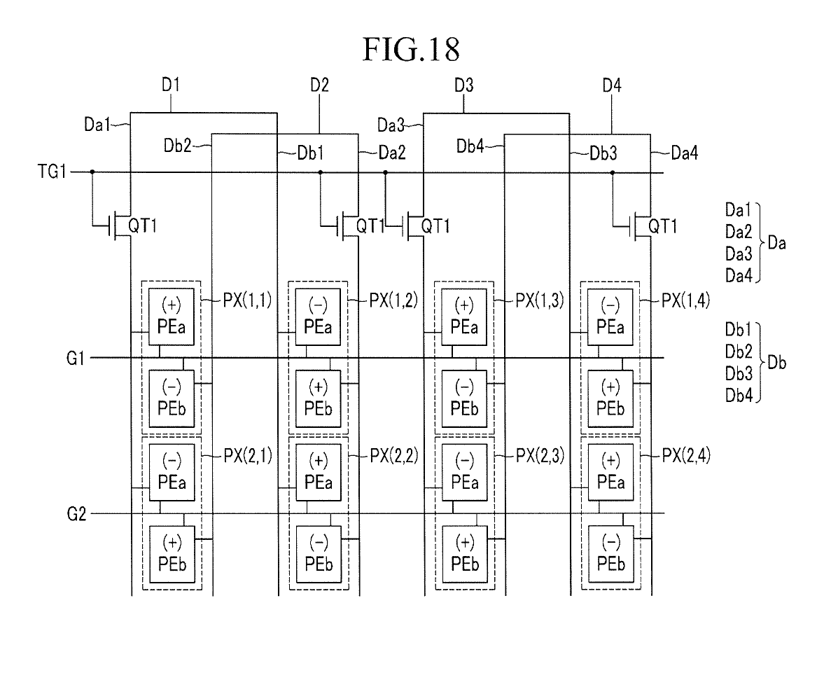

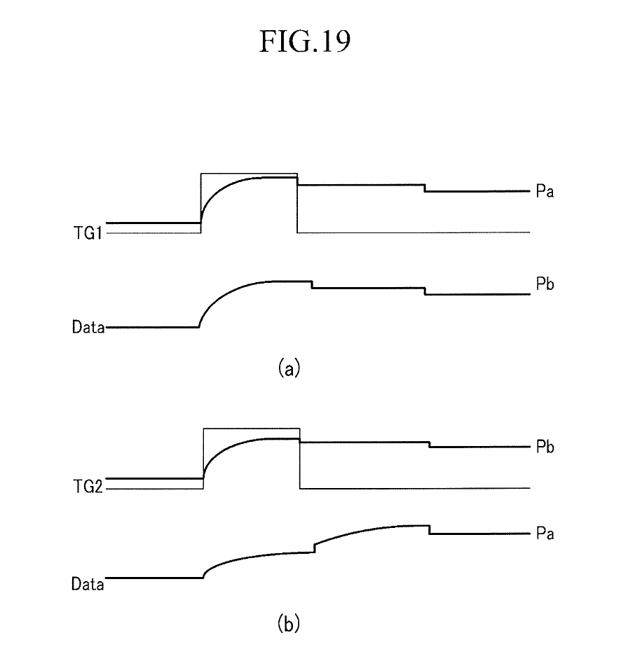

Next, a liquid crystal display and a driving method thereof according to another exemplary embodiment of the present invention will be described with reference to FIG. 18 and FIG. 19. FIG. 18 is a layout view of an arrangement of a signal line and a pixel of a liquid crystal display according to another exemplary embodiment of the present invention, and FIG. 19 is a waveform diagram of a signal applied to the signal line of the liquid crystal display of FIG. 18.

Firstly, referring to FIG. 18, the liquid crystal display according to the present exemplary embodiment is similar to the liquid crystal display according to the exemplary embodiment shown in FIG. 16.

However, the liquid crystal display according to the present exemplary embodiment, is different from the liquid crystal display according to the exemplary embodiment shown in FIG. 16, in that among a plurality of data lines D1, D2, D3, D4, a second subdata line Db2 of the second data line D2 is positioned close to a first subdata line Da1 of the first data line D1, a second subdata line Db1 of the first data line D1 is positioned close to the second subdata line Db2 of the second data line D2, and a first subdata line Da2 of the second data line D1 is positioned close to the second subdata line Db1 of the first data line D1. Similarly, among the plurality of data lines D1, D2, D3, D4, a second subdata line Db4 of the fourth data line D4 is positioned close to a first subdata line Da3 of the third data line D3, a second subdata line Db3 of the third data line D3 is positioned close to the second subdata line Db4 of the fourth data line D4, and a first subdata line Da4 of the fourth data line D4 is positioned close to the second subdata line Db3 of the third data line D3.

The connection relation between the signal and the pixel according to the present exemplary embodiment is similar to the liquid crystal display according to the exemplary embodiment shown in FIG. 16.

Among the plurality of data lines D1, D2, D3, D4, the first subdata line Da1 of the first data line D1 is connected to a first subpixel electrode PEa of the pixel PX positioned at the first pixel row and the first pixel column among the plurality of pixels PX, and the second subdata line Db1 of the first data line D1 is connected to a second subpixel electrode PEb of the pixel PX positioned at the first pixel row and the second pixel column. Among the plurality of data lines D1, D2, D3, D4, the first subdata line Da2 of the second data line D2 is connected to the first subpixel electrode PEa of the pixel PX positioned at the first pixel row and the second pixel column, and among the plurality of data lines D1, D2, D3, D4, the second subdata line Db2 of the second data line D2 is connected to the second subpixel electrode PEb of the pixel PX positioned at the first pixel row and the first pixel column. Similarly, among the plurality of data lines D1, D2, D3, D4, the first subdata line Da3 of the third data line D3 is connected to the first subpixel electrode PEa of the pixel PX positioned at the first pixel row and the third pixel column among the plurality of pixels PX, and the second subdata line Db3 of the third data line D3 is connected to the second subpixel electrode PEb of the pixel PX positioned at the first pixel row and the fourth pixel column. Among the plurality of data lines D1, D2, D3, D4, the first subdata line Da4 of the fourth data line D4 is connected to the first subpixel electrode PEa of the pixel PX positioned at the first pixel row and the fourth pixel column, and among the plurality of data lines D1, D2, D3, D4, the second subdata line Db4 of the fourth data line D4 is connected to the second subpixel electrode PEb of the pixel PX positioned at the first pixel row and the third pixel column.

In the case of the second pixel row, the connection relation between the first subdata line Da and the second subdata line Db, and between the first subpixel electrode PEa and the second subpixel electrode PEb, is opposite to the first pixel row.

In more detail, among the plurality of data lines D1, D2, D3, D4, the first subdata line Da1 of the first data line D1 is connected to the second subpixel electrode PEb of the pixel PX positioned at the second pixel row and the first pixel column among the plurality of pixels PX, and the second subdata line Db1 of the first data line D1 is connected to the first subpixel electrode PEa of the pixel PX positioned at the second pixel row and the second pixel column. Among the plurality of data lines D1, D2, D3, D4, the first subdata line Da2 of the second data line D2 is connected to the second subpixel electrode PEb of the pixel PX positioned at the second pixel row and the second pixel column, and among the plurality of data lines D1, D2, D3, D4, the second subdata line Db2 of the second data line D2 is connected to the first subpixel electrode PEa of the pixel PX positioned at the second pixel row and the first pixel column. Similarly, among the plurality of data lines D1, D2, D3, D4, the first subdata line Da3 of the third data line D3 is connected to the second subpixel electrode PEb of the pixel PX positioned at the second pixel row and the third pixel column among the plurality of pixels PX, and the second subdata line Db3 of the third data line D3 is connected to the first subpixel electrode PEa of the pixel PX positioned at the second pixel row and the fourth pixel column. Among the plurality of data lines D1, D2, D3, D4, the first subdata line Da4 of the fourth data line D4 is connected to the second subpixel electrode PEb of the pixel PX positioned at the second pixel row and the fourth pixel column, and among the plurality of data lines D1, D2, D3, D4, the second subdata line Db4 of the fourth data line D4 is connected to the first subpixel electrode PEa of the pixel PX positioned at the second pixel row and the third pixel column.

Although not shown, the first subpixel electrode PEa of each pixel PX is connected to the gate lines G1, G2 and the first subdata line Da of the data lines D1, D2 through a switching element such as a thin film transistor, and the second subpixel electrode PEb of each pixel PX is connected to the gate lines G1, G2 and the second subdata line Db of the data lines D1, D2 through the switching element such as the thin film transistor.

Referring to FIG. 19 along with FIG. 18, as the gate-on voltage is applied to the first gate line G1 and simultaneously the gate-on voltage is also applied to the first driving gate line TG1 such that the first driving transistor QT1 is turned on, the first data voltage Pa is applied to the first subpixel electrode PEa of the pixel PX positioned at the first pixel row and the first pixel column through the first subdata line Da1 of the first data line D1, the first data voltage Pa is applied to the first subpixel electrode PEa of the pixel PX positioned at the first pixel row and the second pixel column through the first subdata line Da2 of the second data line D2, the first data voltage Pa is applied to the first subpixel electrode PEa of the pixel PX positioned at the first pixel row and the third pixel column through the first subdata line Da3 of the third data line D3, and the first data voltage Pa is applied to the first subpixel electrode PEa of the pixel PX positioned at the first pixel row and the fourth pixel column through the first subdata line Da4 of the fourth data line D4. Simultaneously, the first data voltage Pa is applied to the second subpixel electrode PEb of the pixel PX positioned at the first pixel row and the second pixel column through the second subdata line Db1 of the first data line D1, the first data voltage Pa is applied to the second subpixel electrode PEb of the pixel PX positioned at the first pixel row and the first pixel column through the second subdata line Db2 of the second data line D2, the first data voltage Pa is applied to the second subpixel electrode PEb of the pixel PX positioned at the first pixel row and the fourth pixel column through the second subdata line Db3 of the third data line D3, and the first data voltage Pa is applied to the second subpixel electrode PEb of the pixel PX positioned at the first pixel row and the third pixel column through the second subdata line Db4 of the fourth data line D4.

Next, if the signal TG1 applied to the first driving gate line TG1 is changed into the gate-off signal, the signal is not applied to the first subdata line Da connected thereto, the second data signal Pb applied to the data lines D1, D2, D3, D4 is applied to the second subpixel electrode PEb of the pixel PX positioned at the first pixel row and the second pixel column through the second subdata line Db1 of the first data line D1, is applied to the second subpixel electrode PEb of the pixel PX positioned at the first pixel row and the first pixel column through the second subdata line Db2 of the second data line D2, is applied to the second subpixel electrode PEb of the pixel PX positioned at the first pixel row and the fourth pixel column through the second subdata line Db3 of the third data line D3, and is applied to the second subpixel electrode PEb of the pixel PX positioned at the first pixel row and the third pixel column through the second subdata line Db4 of the fourth data line D4.

Next, the signal applied to the first gate line G1 is changed into the gate-off signal, and the signal applied to the second gate line G2 is changed into the gate-on signal. The second gate line G2 is supplied with the gate-on signal and simultaneously the first driving gate line TG1 is also supplied with the gate-on voltage such that the first driving transistor QT1 is turned on, the second data voltage Pb is applied to the second subpixel electrode PEb of the pixel PX positioned at the second pixel row and the first pixel column through the first subdata line Da1 of the first data line D1, the second data voltage Pb is applied to the first subpixel electrode PEa of the pixel PX positioned at the second pixel row and the first pixel column through the second subdata line Db2 of the second data line D2, the second data voltage Pb is applied to the first subpixel electrode PEa of the pixel PX positioned at the second pixel row and the fourth pixel column through the second subdata line Db3 of the third data line D3, and the second data voltage Pb is applied to the first subpixel electrode PEa of the pixel PX positioned at the second pixel row and the third pixel column through the second subdata line Db4 of the fourth data line D4. Simultaneously, the second data voltage Pb is applied to the first subpixel electrode PEa of the pixel PX positioned at the second pixel row and the second pixel column through the second subdata line Db1 of the first data line D1, the second data voltage Pb is applied to the first subpixel electrode PEa of the pixel PX positioned at the second pixel row and the first pixel column through the second subdata line Db2 of the second data line D2, the second data voltage Pb is applied to the first subpixel electrode PEa of the pixel PX positioned at the second pixel row and the fourth pixel column through the second subdata line Db3 of the third data line D3, and the second data voltage Pb is applied to the first subpixel electrode PEa of the pixel PX positioned at the second pixel row and the third pixel column through the second subdata line Db4 of the fourth data line D4.

Next, if the signal TG2 applied to the first driving gate line TG2 is changed into the gate-off signal, the signal is not applied to the first subdata line Da connected thereto, the first data voltage Pa applied to the data lines D1, D2, D3, D4 is applied to the pixel PX positioned at the second pixel row and the second pixel column through the second subdata line Db1 of the first data line D1, is applied to the first subpixel electrode PEa of the pixel PX positioned at the second pixel row and the first pixel column through the second subdata line Db2 of the second data line D2, is applied to the first subpixel electrode PEa of the pixel PX positioned at the second pixel row and the fourth pixel column through the second subdata line Db3 of the third data line D3, and is applied to the first subpixel electrode PEa of the pixel PX positioned at the second pixel row and the third pixel column through the second subdata line Db4 of the fourth data line D4.

According to the liquid crystal display and the driving method according to the exemplary embodiment shown in FIG. 18 and FIG. 19, although the data voltage applied through the first subdata lines Da1, Da3 of the first data line D1 and the third data line D3 has the positive polarity (+), the data voltage applied through the second subdata lines Db1, Db3 applied through the first data line D1 and the third data line D3 has the negative polarity (−), the data voltage applied through the first subdata lines Da2, Da4 of the second data line D2 and the fourth data line D4 has the negative polarity (−), and the data voltage applied through the second subdata lines Db2 and Db4 of the second data line D1 and the fourth data line D4 has the positive polarity (+), the polarity of each pixel PX may be determined through dot inversion. That is, while the data lines D1, D2, D3, D4 are driven with the column inversion, the polarity of each pixel PX may be determined through dot inversion.

According to the liquid crystal display according to the present exemplary embodiment, the pixel PX is divided into two subpixel electrodes PEa, PEb, the two subpixel electrodes PEa, PEb are respectively connected to the two subdata lines Da, Db extended from the data lines D1, D2, D3, D4, and the data voltage is applied by using the data driving switching element QT2 connected to the second subdata line Db of the two subdata lines Da, Db, and thereby the data voltages of different magnitudes may be applied to the two subpixel electrodes PEa, PEb while reducing the number of data lines by half. Accordingly, while improving the lateral visibility of the liquid crystal display, the cost of the driver can be reduced and the lack of space to mount the data driver can be prevented.

Also, while the data lines D1, D2, D3, D4 are driven with the column inversion, the polarity of each pixel PX may be determined through dot inversion. Further, the subpixel electrode that is secondly charged is pre-charged with the data voltage applied to the subpixel electrode that is firstly charged, and then is currently charged such that the charging time of the data signal is long.

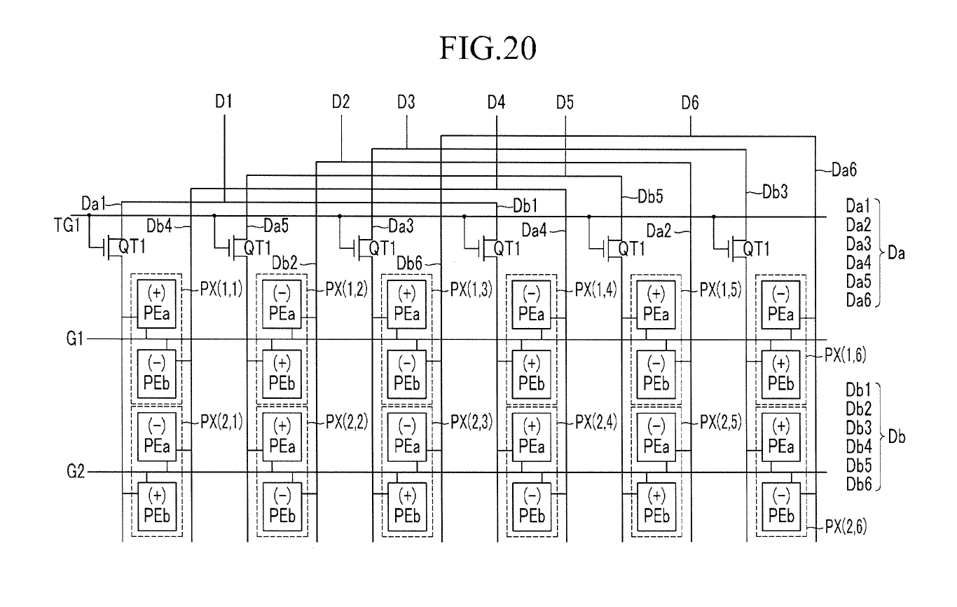

Next, a liquid crystal display and a driving method thereof according to another exemplary embodiment of the present invention will be described with reference to FIG. 20. FIG. 20 is a layout view of an arrangement of a signal line and a pixel of a liquid crystal display according to another exemplary embodiment of the present invention.

Referring to FIG. 20, in the liquid crystal display according to the present exemplary embodiment, a first subdata line Da1 of a first data line D1 is sequentially connected to a first subpixel electrode PEa and a second subpixel electrode PEb of a pixel positioned in a first pixel column, and a second subdata line Db1 of the first data line D1 is sequentially connected to the second subpixel electrode PEb and the first subpixel electrode PEa positioned at a pixel of the fourth pixel column. Also, a first subdata line Da3 of a fourth data line D4 is sequentially connected to the first subpixel electrode PEa and the second subpixel electrode PEb of the pixel positioned at the fourth pixel column, and a second subdata line Db3 of the fourth data line D4 is sequentially connected to the second subpixel electrode PEb and the first subpixel electrode PEa of the pixel positioned at the first pixel column.

Similarly, a first subdata line Da2 of the second data line D2 is sequentially connected to the second subpixel electrode PEb and the first subpixel electrode PEa of the pixel positioned at the fifth pixel column, and the second subdata line Db2 of the second data line D2 is sequentially connected to the first subpixel electrode PEa and the second subpixel electrode PEb of the pixel positioned at the second pixel column pixel. Also, a first subdata line Da5 of the fifth data line D5 is sequentially connected to the second subpixel electrode PEb and the first subpixel electrode PEa of the pixel positioned at the second pixel column, and a second subdata line Db5 of the fifth data line D5 is sequentially connected to the first subpixel electrode PEa and the second subpixel electrode PEb of the pixel positioned at the second pixel column.

Also, the first subdata line Da3 of the third data line D3 is sequentially connected to the first subpixel electrode PEa and the second subpixel electrode PEb of the pixel positioned at the third pixel column, and the second subdata line Db3 of the third data line D3 is sequentially connected to the second subpixel electrode PEb and the first subpixel electrode PEa of the pixel positioned at a sixth pixel column. Also, a first subdata line Da6 of the sixth data line D6 is sequentially connected to the first subpixel electrode PEa and the second subpixel electrode PEb of the pixel positioned at the sixth pixel column, and a second subdata line Db6 of the sixth data line D6 is sequentially connected to the second subpixel electrode PEb and the first subpixel electrode PEa of the pixel positioned at the third pixel column.

The pixels of the first pixel column and the pixels of the fourth pixel column may display the same color, the pixels of the second pixel column and the pixels of the fifth column may display the same color, and the pixels of the third pixel columns and the pixel of the sixth columns may display the same color.

The arrangements and the driving methods of the signal line and the pixel of the liquid crystal display according to the exemplary embodiment may be applied to pixel structures of all shapes including the first subpixel electrode and the second subpixel electrode connected to different switching elements.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a plurality of pixels disposed in a pixel row direction and a pixel column direction and including a first subpixel electrode and a second subpixel electrode; and
a plurality of gate lines and a plurality of data lines connected to the plurality of pixels,
wherein the plurality of data lines respectively include a first subdata line and a second subdata line,
the first subpixel electrode and the second subpixel electrode of a plurality of pixels positioned at the same pixel row among the plurality of pixels are connected to the same gate line, and
the first subpixel electrode of a plurality of pixels positioned at the same pixel column among the plurality of pixels is connected to one of the first subdata line and the second subdata line, while the second subpixel electrode is connected to the other of the first subdata line and the second subdata line.

2. The liquid crystal display of claim 1, wherein absolute values of a first data voltage applied to the first subpixel electrode and a second data voltage applied to the second subpixel electrode are different.

3. The liquid crystal display of claim 2, further comprising:
a first driving gate line extending in the same direction as the gate line; and
a first driving transistor connected to the first driving gate line, the data line, and the first subdata line.

4. The liquid crystal display of claim 3, further comprising:
a second driving gate line extending in the same direction as the gate line; and
a second driving transistor connected to the second driving gate line, a data line, and the second subdata line.

5. The liquid crystal display of claim 2, further comprising:
a second driving gate line extending in the same direction as the gate line; and
a second driving transistor connected to the second driving gate line, a data line, and the second subdata line.

6. The liquid crystal display of claim 1, wherein:
the plurality of gate lines include a first gate line connected to a first pixel row among the plurality of pixels and a second gate line connected to a second pixel row adjacent to the first pixel row among the plurality of pixels and positioned close to the first gate line,
the plurality of data lines include a first data line and a second data line positioned close to the first data line, and
a first subdata line of the first data line is connected to a first subpixel electrode of a pixel positioned at a first pixel row and a first pixel column among the plurality of pixels, a second subdata line of the first data line is connected to a second subpixel electrode of a pixel positioned at the first pixel row and a second pixel column, and
a first subdata line of the second data line is connected to the first subpixel electrode of the pixel positioned at the first pixel row and the second pixel column, and the second subdata line of the second data line is connected to the second subpixel electrode of the pixel positioned at the first pixel row and the first pixel column.

7. The liquid crystal display of claim 6, wherein:
the first subdata line of the first data line is connected to a second subpixel electrode of a pixel positioned at a second pixel row and the first pixel column among the plurality of pixels, the second subdata line of the first data line is connected to a first subpixel electrode of a pixel positioned at a second pixel row and the second pixel column, and
the first subdata line of the second data line is connected to a second subpixel electrode of the pixel positioned at the second pixel row and the second pixel column of the pixel, and a second subdata line of the second data line is connected to the first subpixel electrode of the pixel positioned at the second pixel row and the first pixel column of the pixel.

8. The liquid crystal display of claim 7, further comprising:
a first driving gate line extending in the same direction as the gate line, and
a first driving transistor connected to the first driving gate line, the data line, and the first subdata line.

9. The liquid crystal display of claim 8, further comprising:
a second driving gate line extending in the same direction as the gate line; and
a second driving transistor connected to the second driving gate line, the data line, and the second subdata line.

10. The liquid crystal display of claim 7, wherein the plurality of data lines include the first subdata line of the first data line, the second subdata line of the second data line, the first subdata line of the second data line, and the second subdata line of the first data line, sequentially positioned.

11. The liquid crystal display of claim 7, wherein the plurality of data lines include the first subdata line of the first data line, the second subdata line of the second data line, the second subdata line of the first data line, and the first subdata line of the second data line, sequentially positioned.

12. The liquid crystal display of claim 1, wherein:
the plurality of pixels include a first pixel column and a fourth pixel column displaying a first color, a second pixel column and a fifth pixel column displaying a second color, and a third pixel column and a sixth pixel column displaying a third color,
the plurality of data lines include a first data line and a fourth data line connected to the first pixel column and the fourth pixel column, a second data line and a fifth data line connected to the second pixel column and the fifth pixel column, and a third data line and a sixth data line connected to the third pixel column and the sixth pixel column, and
a first subdata line of the first data line is connected to the first subpixel electrode of a pixel positioned at the first pixel column, a second subdata line of the first data line is connected to the second subpixel electrode of a pixel positioned at the fourth pixel column, a first subdata line of the fourth data line is connected to the first subpixel electrode of a pixel positioned at the fourth pixel column, and a second subdata line of the fourth data line is connected to a second subpixel electrode of the first pixel column.

13. The liquid crystal display of claim 12, wherein:
a first subdata line of the second data line is connected to a first subpixel electrode of a pixel positioned at the second pixel column,
a second subdata line of the second data line is connected to a second subpixel electrode of a pixel positioned at the fifth pixel column,
a first subdata line of the fifth data line is connected to a first subpixel electrode of a pixel positioned at the fifth pixel column, and
a second subdata line of the fifth data line is connected to a second subpixel electrode of the second pixel column.

14. The liquid crystal display of claim 13, wherein:
a first subdata line of the third data line is connected to a first subpixel electrode of the pixel positioned at the third pixel column,
a second subdata line of the third data line is connected to a second subpixel electrode of the pixel positioned at the sixth pixel column,
a first subdata line of the sixth data line is connected to a first subpixel electrode of a pixel positioned at the sixth pixel column, and
a second subdata line of the sixth data line is connected to a second subpixel electrode of the third pixel column.

15. A method of driving a liquid crystal display including a plurality of pixels disposed in a pixel row direction and a pixel column direction and including a first subpixel electrode and a second subpixel electrode, and a plurality of gate lines and a plurality of data lines connected to a plurality of pixels, wherein the plurality of data lines respectively include a first subdata line and a second subdata line, comprising:
applying a gate-on signal to the plurality of gate lines;
applying a first data signal to the first subdata line during a first time among application of the gate-on signal to apply the first data signal to the first subpixel electrode; and
applying a second data signal to the second subdata line during a second time among the application of the gate-on signal to apply the second data signal to the second subpixel electrode.

16. The method of claim 15, wherein absolute values of a first data voltage applied to the first subpixel electrode and a second data voltage applied to the second subpixel electrode are different from each other.

17. The method of claim 16, wherein the applying the first data signal to the first subdata line further includes turning on a first driving transistor connected to a first driving gate line extending in the same direction as a gate line, a data line, and the first subdata line.

18. The method of claim 17, wherein the applying the second data signal to the second subdata line includes turning on a second driving transistor connected to a second driving gate line extending in the same direction as the gate line, the data line, and the second subdata line.

19. The method of claim 15, wherein the first time and the second time are about half of a maintaining time of the application step of the gate-on signal.

20. The method of claim 15, wherein at least a portion of the first time and the second time overlap each other.

21. The method of claim 15, further comprising applying the first data signal to the second subdata line during the first time.

22. The method of claim 15, further comprising applying a second data signal to the first subdata line during the second time.

23. The method of claim 15, wherein the first data signal applied to the first subdata line and the second data signal applied to the second subdata line are driven through column inversion.

24. The method of claim 15, wherein the first data signal applied to the first subdata line and the second data signal applied to the second subdata line are driven through dot inversion.
